(19) United States
(12) Patent Application Publication
(10) Pub. No.: US 2011/0284394 A1
(43) Pub. Date: Nov. 24, 2011

(54) Portable Electrochemical Multiphase Microreactor for Sensing Trace Chemical Vapors

(75) Inventors: Richard I. Masel, Champaign, IL (US); Chelsea Monty, Savoy, IL (US); Ilwhan Oh, Seoul (KR)

(73) Assignee: The Board of Trustees of the University Illinois Office Technology, Urbana, IL (US)

(21) Appl. No.: 12/525,873

(22) PCT Filed: Feb. 14, 2008
(86) PCT No.: PCT/US08/53959

§ 371 Date: Nov. 15, 2010

Related U.S. Application Data
(60) Provisional application No. 60/889,884, filed on Feb. 14, 2007.

(51) Int. Cl. G01N 27/414; B23P 17/04; G01N 27/416

(52) U.S. Cl. 205/783; 204/415; 29/592.1

(57) ABSTRACT

A multiphase microreactor includes gas and liquid microchannels separated by a nanoporous membrane. Rapid mass transfer of gas samples into the liquid electrolyte allows the microchannel/membrane assembly to be used as a fast and sensitive gas sensor. When the oxime chemistry is adapted into the microchannel sensor, the microchannel sensor selectively responds to organophosphates and organophosphate simulants. In addition, a double microchannel design may be used to reduce voltage drift and incorporate a reference electrode into the sensor assembly. Methods of detecting organophosphates are also disclosed.

### STATEMENT AS TO RIGHTS TO INVENTIONS MADE UNDER FEDERALLY SPONSORED RESEARCH AND DEVELOPMENT

This invention was made, at least in part, with U.S. government support under the Defense Advanced Research Projects Agency (DARPA) under U.S. Air Force Grant FA8650-04-1-7121. The Government has certain rights in this invention.

### BACKGROUND OF THE INVENTION

1. Field of the Invention

The invention relates generally to a novel gas chemical sensor that may be used to detect trace vapors present in the air and water. In particular, the gas chemical sensor includes liquid/gas microchannels separated by a nanoporous membrane. When oxime-containing molecules, for example, are introduced into the microchannel sensor, it provides enhanced selective responses to trace vapor of organophosphorous molecules and their simulants within approximately ten seconds. A double microchannel design may further reduce potential voltage drift and simplifies the sensor design.

2. Related Art

For the last decade, demand for hazardous materials sensors, has increased. In order to reduce the harmful effect of hazardous materials on humans, sensors may be used to detect their presence in the air. To effectively detect hazardous materials, sensors must fulfill certain needs. For example, they must allow vapor detection, because the target molecules to be detected are typically in the gas phase rather than in liquid or solid phase. In addition, the sensors should have very high sensitivity so that they can detect a vapor concentration of the target molecule at a concentration in the parts-per-billion or even lower. Further, the sensors should be selective and highly reliable to minimize false positives. The sensors should also be small and light so that they are portable and easily carried by a person.

Conventional methods for the detection of gas-phase hazardous chemicals include gas chromatography/mass spectroscopy (GC/MS), ion mobility spectrometry (IMS), surface acoustic wave (SAW) array sensors, and flame photometric detectors (FPD). However, there are limitations associated with these methods. GC/MS is typically not suitable for portable applications and is also more expensive than other technologies. IMS and FPD are fast and affordable, but have low chemical selectivity because the intrinsic detection mechanism of IMS and FPD is not based on the chemical nature of the target molecule. Instead, both methods are based on a sensing mechanism that has little selectivity, leading to frequent false positives in the field.

On the other hand, sensing mechanisms that utilize specific chemical or biological reactions with specific toxins inherently show high selectivity. For example, chemical sensor-based detectors for organophosphorous (OP) compounds, are of special interest due to the toxicity of OP compounds to humans and other organisms. OP toxins cause paralysis of the nervous system. Acetylcholinesterase (AChE), an enzyme which decomposes the neurotransmitter acetylcholine, is inhibited by these OP toxins. In the human body, the primary function of AChE is the hydrolysis of acetylcholine, the principal step that terminates intercellular communication pathways. The hydrolysis of acetylcholine is shown in Equation (1).

$$acetylcholine + water {\to }^{AChE} choline + acetate$$

OPs inhibit this hydrolysis by irreversibly binding to the active site of AChE. Electrochemical detection of OPs is performed using a derivative of acetylcholine, acetylthiocholine, as shown in Equation (2).

$$acetylthiocholine + water {\to }^{AChE} thiocholine + acetate$$

The thiocholine product is then oxidized on the electrode surface at 400 mV vs Ag/AgCl. When Equation (2) is inhibited, the production of thiocholine is decreased and a decrease in current is found.

Examples of OP sensors that are based on specific chemical or biological reactions include molecularly imprinted sol-gel films, AChE based photonic crystals, OP hydrolase-based sensors, fluorescent chemosensors, and metal-chelate catalysts. Oximes, such as pralidoxime, have been utilized as effective antidotes for OP compounds. These oximes reactivate the inhibited AChE by dissociating the toxin-blocked AChE. Moreover, Green et al. (A. L. Green and B. Saville, J. Chem. Soc., 1956, 3887) showed that the α-keto-oximes hydrolyze sarin and its simulants. They proposed that the oximate anion, which is in equilibrium with oxime, reacts with sarin to yield an intermediate phosphonylated oxime, as shown in FIG. 1. The intermediate then reacts rapidly with hydroxide ion to produce an equivalent amount of cyanide ion. Mono α-keto-oximes produce one mole of cyanide ion per one mole of OP compound; the mechanism for diketo-oximes is more complicated and no simple stoichiometry is observed.

U.S. Pat. No. 3,957,611 to Moll et al. (Moll) showed an oxime-based OP sensor, in which oxime solution is purged with diluted OP gas and the cyanide ions produced are detected by a potential change from a silver electrode. It has the disadvantage though, that it used too large of a quantity of reagents, it produced a cyanide ion product that has a disposal issue, and it was not sufficiently sensitive for water analysis. However, it does not appear that a systematic study of the electrochemical oxime-based OP detection scheme has been conducted.

Microchemical systems including microfluidic systems and/or micro-electro-mechanical systems (MEMS) involving these types of chemical or biological processes have been adapted for portable hazardous material detection. Microchemical systems additionally include benefits such as fast response, high sensitivity, enhanced portability, and reduced reagent volume. In typical microchemical systems, sensor technologies are based on dry solid-state properties such as resistivity. In contrast, most of the chemical/biochemical analysis methods are based on liquid-phase chemistry. For example, conventional AChE-based biosensors have been reported to detect of OP pesticides in water in the liquid phase, but not the gas phase.

To detect vapor phase target molecules, the existing liquid AChE sensor chemistry, such as that described by Moll, may be adapted to a multiphase microreactor. Multiphase microchemical systems contain interfaces and allow reactions of two or more phases (gas, liquid, and/or solid). Fabrication of micro-scale liquid-gas interfaces is especially challenging because, unlike the solid-gas or the solid-liquid interfaces, the liquid-gas interface is inherently fluidic and more difficult to control. Flow at microscale gas-liquid interfaces can be classified into two categories: 1) gas-liquid segmented flow; and 2) gas-liquid parallel flow in surface-modified channels. Gas-liquid segmented flow occurs when two separate flows of gas and liquid are combined into a hydrophobic microchannel. In order to achieve a gas-liquid parallel flow in the microchannel, the wall surface of the microchannel is chemically modified into the hydrophilic and the hydrophobic regions. Then, the liquid flows along the hydrophilic region, while gas flows along the hydrophobic region.

These types of microscale gas-liquid interface flows allow for the gas and liquid to meet at an interface where gas may flow across the hydrophobic channel into the liquid. Once the gas enters the liquid, reactions between the liquid and gas may ensue. Such reactions may be tailored to indicate the presence of trace harmful vapors.

Accordingly, there is a need for a multiphase microreactor that has a microscale gas-liquid interface for use in a gas-phase chemical sensor. A multiphase microreactor would allow the combination of microsensor technology with analytical chemistry to increase reaction time, sensitivity and selectivity in the detection of hazardous gases. In addition, there is a need for sensors based on specific chemistry/biochemistry that show a much higher selectivity toward the target molecule, which is especially important in the case of hazardous materials sensors.

### SUMMARY OF THE INVENTION

The invention provides a small, light, and portable electrochemical multiphase microreactor having a micro-scale gas-liquid interface for the detection of trace vapors. The invention allows the use of oxime-containing molecules in the multiphase microreactor to build an electrochemical gas sensor that selectively detects trace (part-per-billion or lower) gas-phase organophosphorous (OP) materials. Further, the invention optimizes the conditions for fast and sensitive detection of OP compounds.

According to one aspect of the invention, a microchannel system is provided including a liquid microchannel, a gas microchannel, a membrane arranged between the liquid microchannel and the gas microchannel, wherein the membrane has hydrophobic properties, and an ion selective electrode contacting the liquid microchannel.

The microchannel system may also include a reference electrode coupled to an outlet of said liquid microchannel. The membrane may be a nanoporous membrane having a pore size diameter in the range of about 50 nm and about 400 microns. The liquid microchannel and the gas microchannel may have a depth in the range of about 0.2 mm to about 0.05 mm. The membrane may have a thickness of between about 2 microns and about 500 microns. The liquid microchannel may have a width in the range of about 1 mm and about 0.05 mm. The ion selective electrode may be gold or silver. The membrane may be a polycarbonate membrane, and the ion selective electrode may be about 40 nm thick. The microchannel system may also include a coating on the membrane that causes the membrane to have the hydrophobic properties. The membrane may be etched from a silicon on insulator. The membrane may be a nanoporous membrane, and the pore size diameter may be based on the pressure in said liquid microchannel. The microchannel system may also include a plurality of the liquid microchannels and a plurality of the gas microchannels. The plurality of the liquid microchannels may share an inlet or an outlet. The liquid microchannel may carry an electrolyte comprising an oxime solution, where the oxime solution includes a 1-phenyl-1,2,3,-butanetrione 2-oxime (PBO) in a buffer. The PBO concentration may be in a range between about 10 μM and about 10 mM, and the buffer may have a pH of about 10. The liquid microchannel and the gas microchannel may be formed from a polymer including specifically polydimethylsiloxane elastamer or polycarbonate.

According to another aspect of the invention, a method of detecting organophosphates using a microchannel system comprising a liquid microchannel, a gas microchannel, and a membrane having hydrophobic properties, is provided: The method includes coupling a reference electrode to an outlet of the liquid microchannel, adding an electrolyte solution including an oxime compound to the liquid microchannel, adding a gas including an organophosphate compound to the gas microchannel; and measuring the open-circuit potential between the ion selective electrode and the reference electrode.

The membrane may have a pore size diameter in the range of about 50 nm and about 200 microns, and the membrane may be arranged between the liquid microchannel and the gas microchannel. The oxime solution may be a 1-phenyl-1,2,3,-butanetrione 2-oxime (PBO) in a borate buffer compound microchannel. The thickness of the membrane may be between about 2 microns and about 500 microns.

According to another aspect of the invention, a method for forming a microchannel system is provided that includes the steps of forming a gas microchannel, forming a liquid microchannel configured to receive an oxime compound, forming a membrane having hydrophobic properties, arranging the membrane between the liquid microchannel and the gas microchannel, arranging an ion selective electrode in contact with the liquid microchannel, and arranging a reference electrode at an outlet of the liquid microchannel.

The step of forming the membrane may include forming a nanoporous membrane having a pore size diameter in the range of about 50 nm and about 400 microns. The steps of forming the microchannels may include forming the liquid microchannel and the gas microchannel to a depth in the range of about 0.2 mm to about 0.05 mm. The step of forming the membrane may include forming to a thickness of between about 2 microns and about 500 microns. The step of forming the liquid microchannel may include forming to a width in the range of about 1 mm and about 0.05 mm. The ion selective electrode may be gold or silver.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 illustrates the mechanism of reaction between mono-α-keto-oxime and an organophosphorous compound; wherein R=; R¹=; R²=; and X=a leaving group;

FIG. 2A is a schematic diagram of the microchannel sensor constructed according to principles of the invention. The gas microchannel and the liquid microchannel are aligned to each other and are separated by a nanoporous membrane. The liquid side the nanoporous membrane is an electrode material;

FIG. 2B is a profile showing the cross sections of the microchannel/membrane assembly of FIG. 2A;

FIG. 2C is a scanning electron microscope (SEM) image of the nanoporous membrane;

FIG. 2D is an expanded view of the microchannel sensor shown in FIG. 2A;

FIG. 2E is a photograph showing the microchannel sensor of the invention next to a standard U.S. penny;

FIG. 3 is an optical microscope image of the microchannel sensor of the invention for a visualization of the mass transfer and reaction in the microchannel. On the left image, the microchannel is the about 500-μm liquid microchannel containing bromocresol green, a pH indicator. The wider microchannel is the gas microchannel beneath the liquid microchannel and the nanoporous membrane. When about 1 ppm acetic anhydride vapor is passed along the gas microchannel at a flow rate of about 10 mL/min, the liquid microchannel changes color (turns yellow) within a few seconds, as shown on the right image.

FIG. 4 is a plot illustrating the potential response from a microchannel sensor constructed according to the invention. The liquid microchannel contains oxime solution. Along the gas microchannel, 10 ppb acetic anhydride vapor is passed from about t=10 sec (flow rate of about 10 mL/min);

FIGS. 5A, 5B, and 5C illustrate a double microchannel design constructed according to principles of the invention. FIG. 5A shows a liquid microchannel (width of about 500 μm; depth of about 100 μm); FIG. 5B shows a gas microchannel (width of about 1000 μm; depth of about 100 μm); and FIG. 5C shows an optical microscope image of the assembled microchannel sensor net to a U.S. penny;

FIGS. 6A and 6B are plots illustrating a potential response from the double microchannel sensor package. In FIG. 6(A), the potential output from the amplifier/filter is initially adjusted close to zero. At about t=10 sec, 10 ppb acetic anhydride vapor is introduced into the gas microchannel. When the potential response reaches ˜500 mV, the gas flow is stopped. After regeneration, (about t=120 sec) the sensor can be used again, as shown in FIG. 6(A). In FIG. 6(B), a long term stability of the sensor response is illustrated. The baseline of the response is measured over a period of 12 hours. The baseline of the response is generally quite stable and the variation range is less than about 15 mV;

FIG. 7 illustrates a stand-alone sensor package constructed according to principles of the invention. The package is composed of a double microchannel sensor, vials for liquid source and drain, and battery-operated miniature amplifier/filter electronics.

FIG. 8 is a plot of electrode potential response of CN ISE in about 5 mM PBO and about 25 mM borate buffer (pH=10)(solid line). About 50 μM acetic anhydride is injected at t=0 s. For control (dashed line), about 50 mM acetic anhydride injected at t=0 s into blank about 25 mM borate buffer (pH=10) in the absence of oxime;

FIG. 9A shows the chemical structure of malathion;

FIG. 9B is a plot illustrating the potential response of CN ISE to OP pesticide malathion. The straight line shows the results from about 67 μM malathion being injected at t=0 s into the stirred solution of about 5 mM PBO+25 mM borate buffer (pH 10). In a control experiment (dashed), about 67 μM malathion was injected at t=0 s into the stirred blank solution containing no oxime;

FIG. 10A illustrates the chemical structures of four different oximes tested: 1-phenyl-1,2,3,-butanetrione 2-oxime (PBO), 1,3-diphenyl-1,2,3-propanetrione 2-oxime (DPO), anti-pyruvic aldehyde 1-oxime (PAO), 2-isonitrosoacetophenone (IAP). PBO and DPO are diketooximes, while PAO and IAP are monoketo-oximes;

FIG. 10B is a plot illustrating the potential response of CN ISE in the different oximes of FIG. 10A;

FIG. 11 is a plot of electrode potential vs. solution pH. Three different potentials are plotted: Einit, initial potential (long dash), Efinal, final potential (dash) and delta E=Efinal−Einit (straight) of CN ISE in about a 5 mM PBO and about 25 mM borate buffer in the pH rante of 9-12;

FIG. 12 is a plot of potential difference delta E of CN ISE vs. log [AA] when a range of AA concentration is injected into the stirred solution of about 5 mM PBO+25 mM borate buffer (pH 10);

FIG. 13 is a plot of QCM for cross-linking of AChE with BSA. About 30 uL of 2.5% glutaraldehyde was added to a solution of about 15 uL (314 U/mL) AChE, 8 mg BSA, and about 300 uL of phosphate buffer (pH=7.4). The sharp rise in negative delta frequency corresponds to the gel point. A decrease in negative delta frequency corresponds to the drying of the gel;

FIG. 14A shows a plot of current vs. pH for the hydrolysis of thiocholine from about 1 mM acetylthiocholine in a about 2 U/mL AChE in phosphate (diamond) and borate (square) buffers at about 400 mV vs. Ag/AgCl;

FIG. 14B shows a plot of current vs. pH for the hydrolysis of about 1 mM acetylthiocholine in phosphate (diamond) and borate (square) buffer solutions with about 0.4 U of AChE;

FIG. 15 shows a plot of current vs. temperature for the hydrolysis of thiocholine from 1 mM acetylthiocholine in about 2 U/mL AChE in phosphate buffer (pH=7.4). The optimum temperature of the enzyme is approximately 37 degrees Celsius. Enzyme degradation occurs, as shown by a decrease in current, above about 40 degrees Celsius;

FIG. 16 shows thiocholine oxidation current vs. potential (vs. Ag/AgCl) for a beaker-scale experiment at a scan rate of about 25 mV/sec, with A) about 1.25 mM acetylthiocholine over immobilized AChE (18 U/mL), incubated for 30 minutes, and B) the same solution as A) with about 23 mM malathion added. Curve B overlays the background in phosphate buffer (pH=7.4). Comparing A) and B) shows that the addition of about 46 μM malathion inhibits the oxidation of thiocholine by 100% at a potential of about 700 mV. Percent inhibition is calculated as [Iᵢₙᵢₜᵢₐₗ−I_{inhibited}]/Iᵢₙᵢₜᵢₐₗ;

FIG. 17 is a plot of thiocholine oxidation current in microreactor for various acetylthiocholine concentrations at an acetylthiocholine flow rate of about 0.01 mL/min over about 14 U/mL of immobilized AChE at about 800 mV. The response increases linearly until approximately about 2 mM, then the enzyme catalyst becomes saturated and the sensor response plateaus. The background is ATCh oxidation at a flowrate of about 0.01 mL/min without immobilized enzyme. The background does not increase with increasing ATCh concentration;

FIG. 18 is a bar graph comparison of sensor response for about 1.69 mM acetylthiocholine, about 0.013 U AChE, phosphate buffer (pH=7.4) solution with the working electrode only on the nanoporous membrane and the working and counter electrodes in tandem on the membrane. The black bars represent immobilized AChE, while the grey bars represent AChE free in solution;

FIG. 19 is a bar graph of percent inhibition after exposure to about 52 ppb malathion in argon carrier gas at a rate of 10 mL/min for immobilized AChE (black) and AChE free in solution (grey). A liquid microchannel contains about 1.69 mM acetylthiocholine in phosphate buffer solution (pH=7.4) flowing at about 0.01 mL/min and about 0.013 U AChE;

FIG. 20 shows thiocholine oxidation current for increasing liquid flow rates of 4 mM acetylthiocholine flowing over about 18 U/mL immobilized AChE. The response increases linearly with flowrate until approximately about 0.13 mL/min. Above 0.13 mL/min, the response levels off and the sensor is not limited by mass-transfer of acetylthiocholine. The sensor response is reported after subtracting out the background from acetylthiocholine and phosphate buffer.

FIG. 21A is the change in frequency (−Δf) due to the thin film for various AChE concentrations for macro-scale QCM experiments. Resonance frequency is at a minimum at about 18 U/mL AChE. Above about 18 U/mL AChE the increase in −Δf shows there is an increase in density and/or viscosity of the gel. Resonance frequency (−Δf) is proportional to (ρ_{gel}*η_{gel})^{1/2} by Kanazawa's equation. FIG. 21B shows thiocholine oxidation current at various AChE concentrations was found for each gel in the liquid microchannel. Thiocholine oxidation current is at a maximum at about 18 U/mL AChE. Above 18 U/mL the increased density and/or viscosity of the gel prevented the acetylthiocholine from reaching the enzyme active site. A comparison of FIGS. 21A and B shows that the thiocholine oxidation current increases as the resonance frequency of the thin film decreases.

FIG. 22 is a plot of thiocholine oxidation current vs. time for response of microsensor to about 0.2 ppb malathion vapor at a vapor flow rate of about 10 mL/min for 40 seconds. The liquid microchannel contains about 1.69 mM acetylthiocholine in a phosphate buffer solution (pH=7.4) flowing at 0.01 mL/min over 13 U/mL of immobilized AChE on bottom of liquid microchannel. In the control, the liquid microchannel contains only phosphate buffer (pH=7.4). Initial response occurs after about 10 seconds and the response is complete after about 40 seconds. The 4 distinct plateaus in the curve correspond to the saturation of each of the 4 AChE active sites with malathion;

FIG. 23 shows percent inhibition due to malathion vapor at various malathion vapor concentrations found by calculating [Iᵢₙᵢₜᵢₐₗ−I_{inhibited}]/Iᵢₙᵢₜᵢₐₗ. The sensor response is saturated at approximately 44% inhibition and the current detection limit of the sensor is about 100 ppt (signal to noise ration=3). Malathion vapor was supplied through the vapor microchannel at about 10 mL/min over a liquid microchannel containing 4 mM acetylthiocholine chloride at a flow rate of about 0.128 mL/min and an immobilized enzyme gel containing about 18 U/mL AChE.

FIG. 24 is a table that illustrates the microsensor response to selected simulants and interferants. The sensor of the invention is highly selective and only shows a response when exposed to the organophosphorus AChE inhibitor malathion. The sensor is also highly sensitive and has a detection limit in the parts-per-trillion (ppt);

FIG. 25 is a plot showing potential response from a thin-layer sensor. A thin layer design with nanoporous membrane dramatically reduces detection time. About 20 mM IBA in borate buffer (pH 10) is used, along with a track-etched Polycarbonate Membrane (Pore size of about 10 nm) with CN ISE. Flow rate of diluted AA vapor=100 mL/min; and

FIG. 26 is a plot illustrating a further reduced detection time using a low-pass filter & instrument amp (Gain=20);

FIG. 27A is a schematic representation of a two-dimensional model for liquid and vapor micro-channels separated by a membrane constructed according to principles of the invention;

FIG. 27B is a graph show simulation results for the organophosphorous concentration profile along the depth of one embodiment of the microreactor constructed according to principles of the invention, where the micro-channels are about 0.0075 cm deep and are separated by about a 0.0006 cm thick membrane and the concentration profile is taken at a position halfway down the length of the microreactor (0.25 cm) after 90 seconds;

FIG. 28 is a graph showing simulation results for the effect of pore size in the nanoporous membrane on sensor response, where the cyanide ion concentration reported is for a microchannel that is about 0.25 mm wide×about 0.1 mm deep×about 5 mm long after a time of about 30 seconds. The simulation results show that with an increase in pore size from about 10 nm to about 100 nm there is an increase in sensor response in the form of an increase in cyanide ion concentration. This result indicates that the mass transfer through the pore is faster with larger pores, leading to a faster response;

FIG. 29 is a graph showing simulation results for the effect of channel depth on cyanide ion concentration, where the micro-channels are about 0.250 m wide and about 10 mm long with about 50 nm pores in the nanoporous membrane. As the channel depth decreases from about 0.2 mm to about 0.05 mm the sensor response increases in the form of an increase in cyanide ion concentration;

FIG. 30 is a graph showing simulation results for the effect of hydrophilicity of the nanoporous membrane on sensor response, where the cyanide ion concentration reported is for a microchannel that is about 0.25 mm wide×about 0.075 mm deep×about 5 mm long after a time of 30 seconds. The simulation results show that a hydrophobic nanoporous membrane has a sensor response that is almost two orders of magnitude larger than a hydrophilic membrane.

FIG. 31 is a graph showing experimental sensor response versus time for the oxime microreactor of the invention after exposure to phosphate vapor. The organophosphorous analyte (100 ppb) is introduced after 15 seconds at a flowrate of about 1 cm3/min and the sensor shows a response almost immediately;

FIG. 32 is a graph showing experimental results for the effect of pore size of the nanoporous membrane on sensor response. As the pore size increases from about 10 nm to about 50 nm the response of the sensor also increases from about 11 mV to about 60 mV, indicating that the mass transfer through the pore is faster with larger pores, leading to a faster response.

FIG. 33 is a graph showing experimental results for the effect of channel depth on sensor response. As the channel depth decreases from about 0.05 mm to about 0.2 mm the sensor response increases, for all channel widths;

FIG. 34 is a graph showing experimental results for the effect of vapor residence time on sensor response. Vapor residence time appears to have very little effect on the sensor response with an average potential response of about 73 mV and a standard deviation of about 8.5 mV;

FIG. 35 is a schematic illustration of a Si based gas sensor constructed according to principles of the invention; and

FIG. 36 is a graph showing a potential response from the Si based sensor illustrated in FIG. 35.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

The invention provides an electrochemical multiphase microreactor having a micro-scale gas-liquid interface to detect trace toxic vapors. In addition, the invention allows the use of oxime-containing molecules a microreactor to build an electrochemical gas sensor that selectively detects trace (part-per-billion or lower) gas-phase organophosphorous (OP) compound. The present invention has incorporated AChE biochemistry into a microreactor containing a micro-scale gas-liquid interface to provide a method to quickly, sensitively, and selectively detect OPs in a portable device. This type, level and sensitivity of detection is not possible in current GC/MS or IMS techniques. Further, the electrochemical sensor of the invention may be used in a wide range of applications.

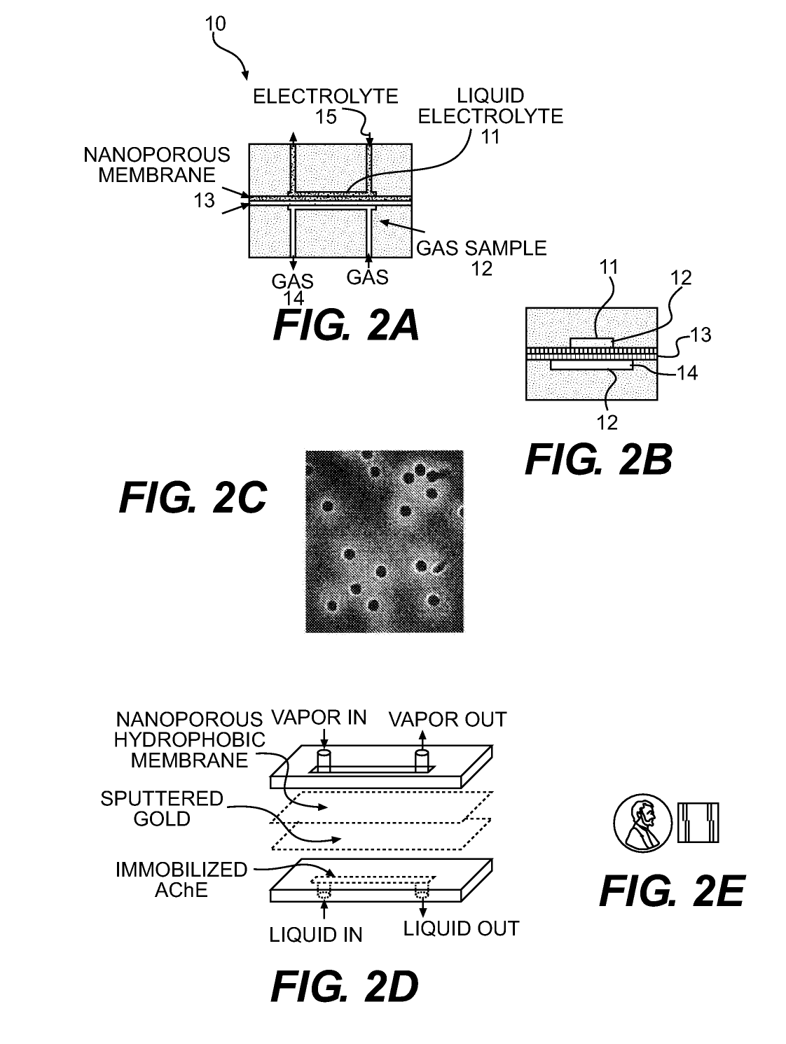

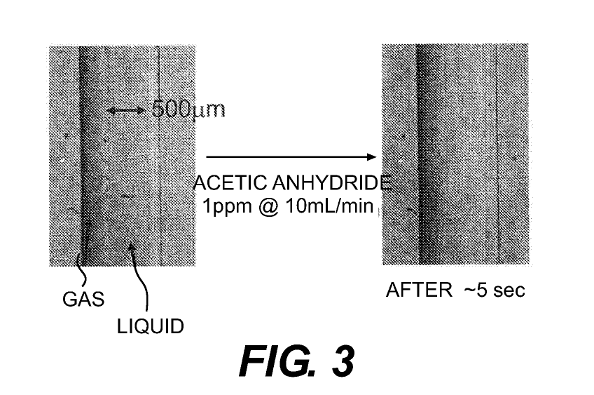

Referring first to the multiphase microreactor, the microreactor includes a microchannel, an ion-selective electrode (ISE), and a nanoporous membrane, which will be described in detail below. In one embodiment of the invention, the microchannel sensors may have a single microchannel, as shown in the schematic diagrams and photographs of the assembled microchannel sensors in FIGS. 2A, 2B, 2C, 2D, 2E and FIG. 3. The microchannel sensor 10 shown in FIG. 2A includes two microchannels 11, 12—one microchannel 11 for a liquid electrolyte 15 and the other microchannel 12 for a gas sample 14. A nanoporous membrane 13 is sandwiched between the two microchannels. The membrane 13 is preferably gas permeable to allow the transport of gas molecules 14 into the liquid electrolyte 15 while containing the liquid in one side. In order to prevent an electrolyte 15 leakage into the gas channel 12, the membrane 14 may have hydrophobic properties and the pore size should be sufficiently small. Although any porous membranes may be used, an embodiment of the invention uses a track-etched polycarbonate membranes with nanometer-size pore. FIG. 2B is a cross-sectional view of the microchannel sensor of FIG. 2A, with the liquid microchannel 11 on top of the membrane 13. As shown in FIG. 2B, the liquid microchannel 11 is narrower than the gas microchannel 12. FIG. 2D is an expanded view of the microchannel sensor shown in FIG. 2A. FIG. 2E is a photograph showing the microchannel sensor of the invention next to a standard U.S. penny, demonstrating its compact size.

The sensor system described herein, including in FIG. 2A-2E may have components of any number of difference dimensions but are particularly advantageous for very small size applications. By way of example, the nanoporous membrane may have a pore size diameter in the range of about 50 nm and about 500 microns. The membrane may have a thickness of between about 2 microns and about 500 microns. The microchannels may have a depth in the range of about 0.2 mm to about 0.05 mm, and a width in the range of about 1 mm and 0.05 mm.

Throughout this invention, a microchannel will be defined as a channel that has one dimension (width, height, length) of less than 1 cm.

The liquid side of the membrane is coated with a thin layer of electrode material (either gold or silver in the current work) to function as a working or reference electrode of the microchannel sensor. For example, the reference electrode may include Ag/AgCl. An electrochemical transducer is chosen because it is generally simpler, cheaper, and more portable than optical transducer or others.

The microchannel/membrane assembly can be regarded as a microscale gas-liquid microreactor. FIG. 3 shows a microscope image of the assembly microchannel sensor. Mass transfer and reaction in the microchannel sensor are visualized in FIG. 3, which shows top-view microscope images of the microchannel sensor.

Compared to the Moll's bubbler design, the electrolyte volume in the microscale gas-liquid microreactor constructed according to principles of the invention is up to six orders of magnitude smaller and the detectable amount of the gas sample is also lowered. This leads not only to a faster detection but also to a production of much less amount of cyanide ion in the final solution, minimizing the disposal issue. In addition, the analysis time of the microscale gas-liquid microreactor is two orders of magnitude less than Moll's bubbler design and the device may be used for water analysis. Further, it uses six orders of magnitude less reagents and produces six orders of magnitude less cyanide ion in the microscale gas-liquid microreactor of the invention. Furthermore, the potential response from the ISE and the Ag/AgCl reference electrode is more stable and reproducible than that from the pure silver and platinum electrode of the Moll's design.

The microreactor may be fabricated by combining microfabrication techniques and electrochemical transducers. The fabrication of the microchannel sensor generally involves the fabrication of a microchannel, deposition of electrode materials onto a nanoporous membrane, and clamping or bonding of the two microchannels and the nanoporous membrane.

In detail, for the single microchannel design, the microchannel may be made by a conventional polydimethylsiloxane (PDMS) mold process. For example, a microchannel mold was made using an SU-8 negative photoresist (thickness of about 50-100 μm) on a clean silicon wafer. After modifying the SU-8 mold surface with (1H,1H,2H,2H-perfluorodecyl) trichlorosilane, a 1:10 mixture of the PDMS elastomer and curing agent (Sylgard 184, Dow Corning. Midland, Mich.) was poured onto the mold and was cured at 65° C. for about 2 hours. The cured PDMS was detached from the mold and cut into an appropriate size. Through-holes were punched to connect the microchannel with outside tubings. A track-etch polycarbonate membrane (wherein pore size may be between about 10 to about 100 nm; thickness of about 10 μm; SPI) was sputtered with about 40-nm gold or silver. The resistance across the sputtered electrode was measured to ensure the electrical connection. The membrane was sandwiched between two PDMS microchannels and the assembly was clamped between two thick polycarbonate holders. Thus, the microchannel was machined into the polycarbonate.

Then the vapor and liquid connections were added using 1/16″ Teflon tubing. A track-etch polycarbonate membrane (pore size about 10, 100 nm; thickness about 10 μm; SPI) was sputtered with about 40-nm gold and is used as the working electrode. The working and counter electrodes may both placed on the membrane. In order to create a two electrode system, a shadow mask may be used during sputtering. The membrane was then sealed between two polycarbonate microchannels using a thin layer of epoxy.

Once the microchannel sensor was formed, the chemical solutions were incorporated into the sensor. In order to build a gas sensor for detection of vapor phase OP compounds, oxime-containing molecules are introduced into the gas-liquid microreactor. It has been shown that oxime-containing molecules react with organophosphorous or its simulants and produces cyanide ion. The produced cyanide ion can be detected by electrochemical potentiometry with a cyanide-selective electrode. The advantage of potentiometry is low power consumption and a large dynamic range.

As described above, the liquid side of the nanoporous membrane is coated with an electrode material. Metallic electrodes are known to respond to cyanide ions. Overall, the electrode response should reflect the oxime reaction in the liquid electrolyte. Thus, the sensor based on the specific chemistry should have a superb selectivity toward the target molecule.

In one embodiment of the invention, a electrolyte including an oxime solution of about 5 mM 1-phenyl-1,2,3,-butanetrione 2-oxime (PBO) (Aldrich Chemical, St Louis, Mo.) in pH 10 borate buffer was used. Although a 5 mM PBO solution is described here, it is understood that other concentrations, such as in a range between about 10 μM and about 10 mM, may also be used. Along with the oxime solution, bromocresol green (about 0.04 wt % water solution purchased from Aldrich), was used as an indicator for visualization experiments shown in FIG. 3. The inner microchannel 11 shown in FIG. 2A is the liquid microchannel and contains the bromocresol green. The bromocresol green remains green at neutral pH and turns yellow at pH lower than 4.

The oxime solution was passed along the liquid microchannel using a manual syringe. The vapor sample was introduced into the gas microchannel using a syringe pump at the flow rate of about 10 mL/min. Alternatively, the chemical vapors may be sampled from pure liquid chemicals in a bubbler and diluted to the desired vapor concentration to be passed along the gas microchannel. The wider microchannel may be the gas microchannel 11, which is located beneath the liquid microchannel 12 and the nanoporous membrane 13, as shown in FIG. 2B. For the single microchannel design, a conventional Ag/AgCl reference electrode (Bioanalytical Systems, Inc., West Lafayette, Ind.) was immersed in the vial that is connected to the outlet of the liquid microchannel. The open-circuit potential between the membrane electrode and the reference electrode was measured as the output signal from the microchannel sensor.

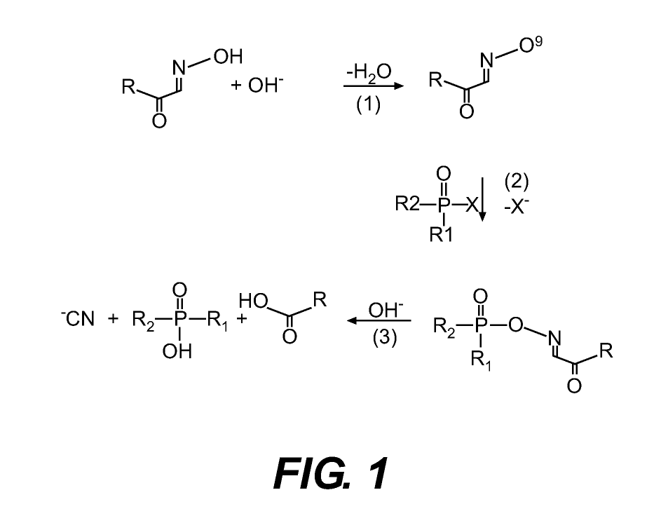

Once the oxime solution filled the liquid microchannel, the microchannel sensor was tested with a vapor of acetic anhydride, which initially reacts with the oxime in a manner similar to the organophosphorous in step 2 of FIG. 1. When 1 ppm acetic anhydride vapor was passed along the gas microchannel, within a few seconds the liquid microchannel turned from green to yellow. The acidic vapor transferred across the nanoporous membrane, dissolved into the liquid, and lowered the solution pH, resulting in the observed color change. The time scale of the process is short enough that the gas-liquid microreactor can be used as a fast gas sensor. In addition, no significant color gradient was observed along the microchannel (length of about 10 mm). The observation indicates that the mass transfer along the channel is quite uniform along the microchannel.

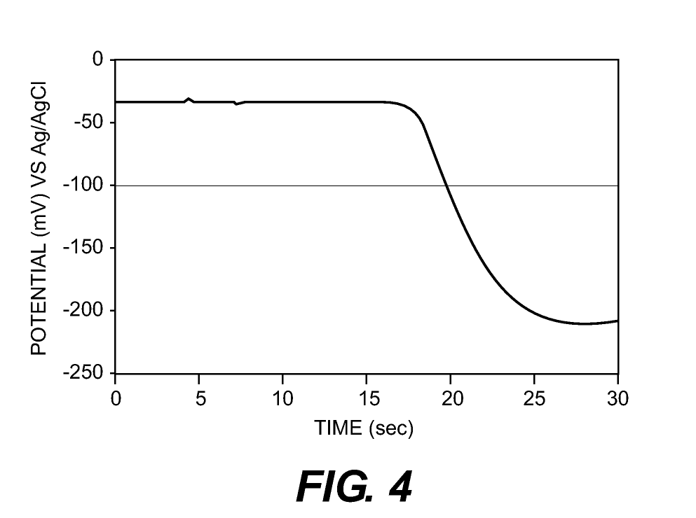

FIG. 4 shows the response when about 10 ppb acetic anhydride vapor was introduced into the gas microchannel at t=10 sec. In FIG. 4, the electrode potential is initially stable at about −30 mV. When the acetic anhydride is introduced at t=10 sec., a potential response of approximately −150 mV was observed within about 20 sec. Compared to the response from the macro-size bubbler cell of Moll, the potential response is at least one order of magnitude faster. The enhanced performance is attributed to the shorter time scale of mass transfer inside the thin microchannel.

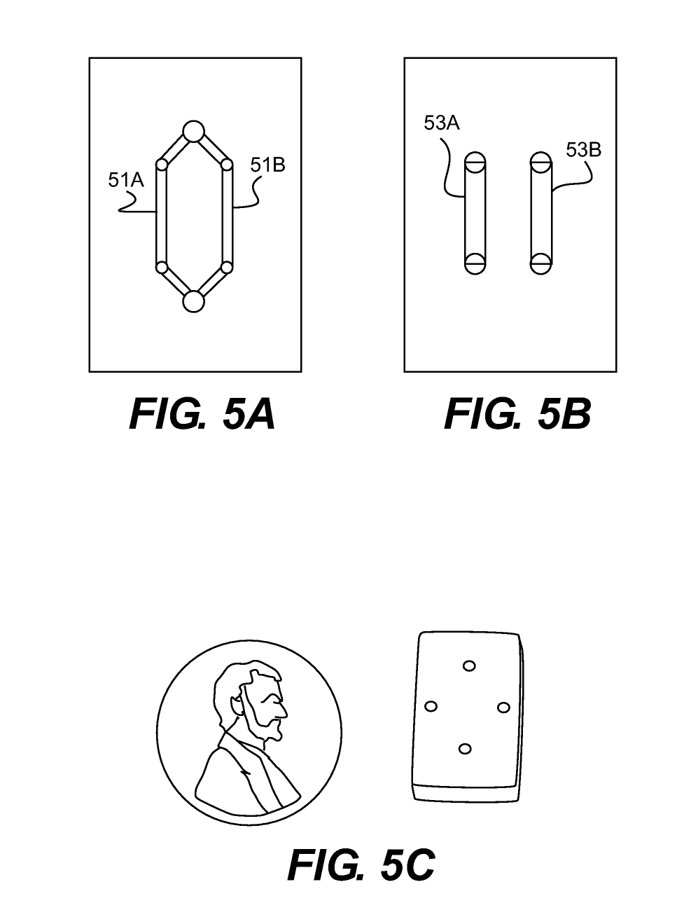

According to another aspect of the invention, the microchannel sensors may have a double microchannel design, as shown in FIGS. 5A, 5B, and 5C. The disadvantages of the single microchannel sensor are that a separate reference electrode is required outside the sensor assembly and a potential drift is often observed when the open-circuit potential of a single electrode is measured. However, when an additional reference microchannel/electrode is incorporated in the double microchannel design, no separate reference electrode is required. Furthermore, any potential drift of the working electrode is cancelled out by the same drift of the reference electrode, dramatically reducing the overall potential drift and setting the initial output potential from the sensor assembly to close to 0.

For this double microchannel design, a surface of polycarbonate chip may be machined into microchannels. As shown in FIG. 5A, the liquid microchannel is split into two microchannels (working 51A and reference 51B, respectively). In FIG. 5B, the two gas microchannels 53A and 53B are fabricated to overlap with the liquid microchannels when the two parts are assembled together. Furthermore, the electrode coating on the nanoporous membrane may be patterned into two electrodes (working and reference, respectively) using a shadow mask. For bonding, a thin layer of epoxy glue may be pressed between two glass slides and carefully transferred to the polycarbonate surface. The nanoporous membrane is sandwiched between the two polycarbonate microchannels in a way that the liquid and gas microchannels and the patterned electrodes are aligned to each other. Then the assembly may be cured at room temperature for 6 hours. FIG. 5C shows the bonded assembly of the double microchannel sensor.

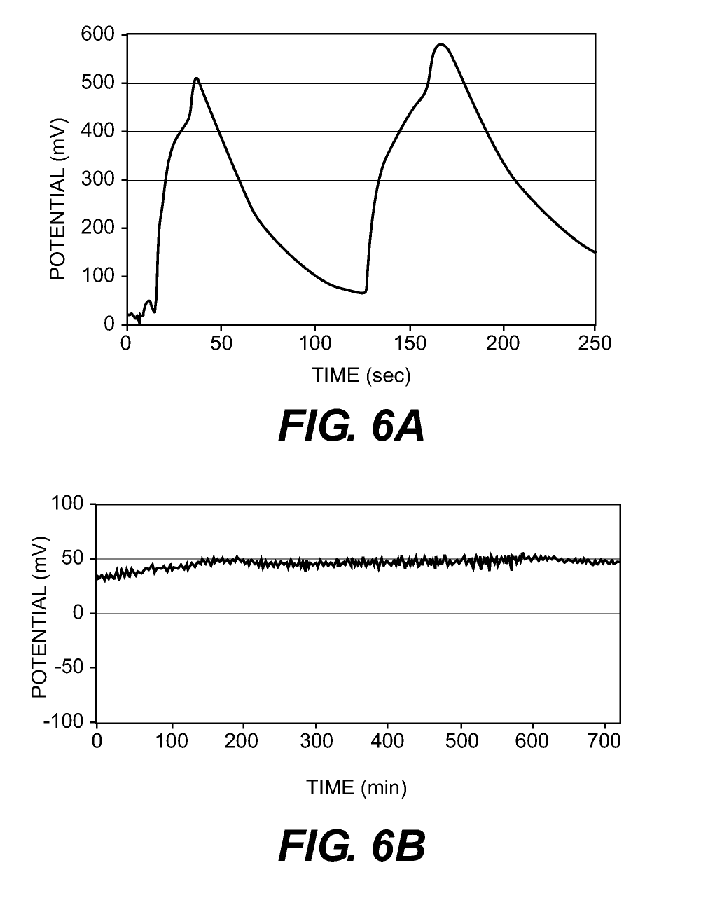

FIG. 6A shows the potentials response from the double microchannel sensor package. Initially, the potential output from the amplifier/filter is adjusted close to zero. At t=10 sec, about 10 ppb acetic anhydride vapor begins to flow along the gas microchannel. Approximately 20 sec after the onset of the gas flow, the potential increases by about 500 mV. When the potential reaches about 500 mV, the gas flow is stopped. A few seconds after the gas flow is stopped, the potential begins to decrease and, about 1 min after the gas flow is stopped, becomes less than about 100 mV. After the regeneration, the sensor can be used again, as shown in FIG. 6(A).

FIG. 6B shows the long term stability of the sensor response. The baseline of the response is measured over a period of 12 hours. The baseline of the response is quite stable and the variation range is less than about 15 mV.

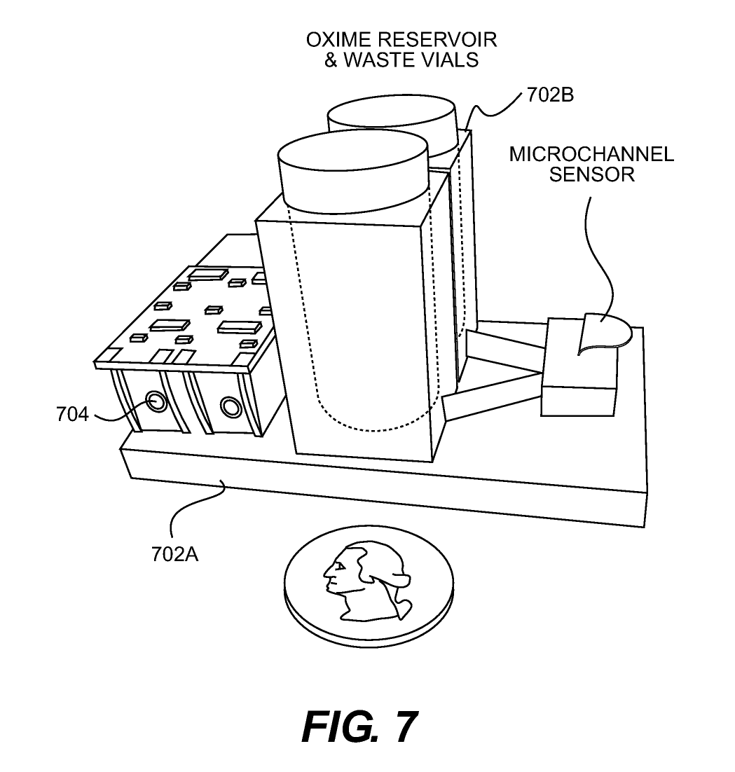

The sensor package shown in FIG. 7 contains two additional components that may be used in the stand-alone operation: liquid source/drain vials 702A and 702B and a miniature amplifier/low pass filter electronics 704. The inlet vial 702A is combined with a gas generating pump, which pushes the liquid into the microchannel by generating hydrogen at a rate of about 0.1-1.0 mL/day. The amplifier/low pass filter electronics 704 is combined with a battery and can operate for as long as 6 months. It amplifies the potential response from the microchannel sensor with a gain of 20. In addition, FIG. 7 shows a stand-alone sensor package, in which the inlet and the outlet of the double microchannel sensor are connected to the liquid source 702A and drain 702B, respectively. Also, the working and the reference electrodes are connected to the miniature amplifier/filter electronics.

In another embodiment of the invention, the bottom of the gas channel was removed and the membrane was directly exposed to ambient air. The response was slower in this case, but the device still functioned.

In another embodiment of the invention, different electrolyte solutions were used, including 1-Phenyl-1,2,3,-butanetrione 2-oxime (PBO), 1,3-diphenyl-1,2,3-propanetrione 2-oxime (DPO, Aldrich), anti-pyruvic aldehyde 1-oxime (PAO, 98%, Aldrich), 2-isonitrosoacetophenone (IAP, 97%) (Fluka Analytical, Seelze Germany), acetic anhydride (99.5%, Aldrich), malathion (97.3%, Aldrich), dimethyl methylphosphate (97%, Aldrich), diethylene glycol monoethyl ether (dowanol; 99%, Aldrich), and isopropyl acetate (99%, Aldrich) as received. To make borate buffer solution, about 25 mM NaB₄O₇.10H₂O (Fisher Scientific Co., Waltham, Mass.) was dissolved, and the solution pH was adjusted by adding concentrated NaOH.

In this embodiment, a cyanide ion selective electrode (CN ISE) (Thermo Electron Co., Waltham, Mass.) with a combined liquid-junction reference electrode was used. The potential of the liquid-junction reference electrode was measured to be 136 mV vs. conventional Ag/AgCl reference electrode (Bioanalytical Systems, Inc., West Lafayette, Ind.). All potentials are reported here with respect to the liquid-junction reference electrode. The surface of the CN ISE was periodically polished to remove any residue on the surface. When the CN ISE was immersed in an oxime solution, the initial electrode potential read 0 to −30 mV. After 30 min, the electrode potential slowly decayed to a stable value. An analyte (0.10 mL solution in acetone) of desired concentration was injected into a 25 mL oxime solution while stirring, and the stirring was stopped 5 seconds after injection. The analyte was freshly prepared just before every injection, to minimize spontaneous decomposition.

The CN ISE was calibrated, by measuring the electrode potential in diluted standard cyanide ion solution (Ricca Chemical, Arlington, Tex.). The electrode potential showed a good linearity in the concentration range of interest (10⁻⁵ to 10⁻³ M) as shown in Equation 3.

E=−66×log [CN⁻]−486 (3)

where E is the electrode potential of CN ISE in mV. The detection limit of CN ISE is approximately 10⁻⁶ M in pH 10 borate buffer.

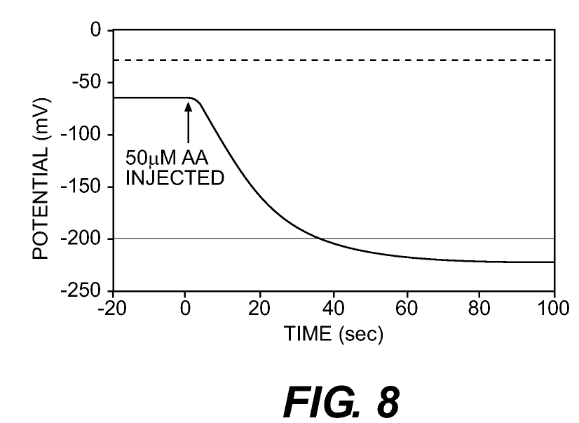

The oxime-based sensor was evaluated and optimized in a two-electrode beaker cell. The cell contained an electrolyte solution of about 5 mM 1-phenyl-1,2,3-butanetrione 2-oxime (PBO) in borate buffer (pH 10). The CN ISE with a liquid-junction reference electrode is immersed in the electrolyte. FIG. 8 shows the typical response of the oxime-based electrochemical OP sensor. Initially, the electrode potential of CN ISE was stable at about −70 mV. When about 50 pM acetic anhydride (AA) was added to the cell at t=0 s, the electrode potential decreased rapidly and reached the final value of about −230 mV after 1 min. From Equation 3, the final concentration of cyanide ion was determined to be about 120 pM, which is 2.4 times the concentration of the injected AA concentration. In a control experiment, (dashed line in FIG. 8) about 50 pM AA is injected at t=0 s into blank solution (with no oxime solution). In the absence of oxime solution, the electrode potential was barely affected by the injection of AA, confirming that the potential response comes from the reaction between an oxime containing molecule and AA which produces cyanide ion.

In the previous embodiment, AA was chosen as an OP simulant to evaluate and optimize the oxime-based sensor. AA has a similar reactivity with oximes when compared to OP toxins because both of them are activated acid analogs, but AA does not inhibit AChE and is a much safer testing alternative to OP toxin. Basically any activated acid analog, such as thionyl chloride, would react with the oxime, interfering with the oxime-based sensor. However, activated acids usually decompose fast in an ambient environment. Thus, it is expected that it is less likely that the activated acids would interfere with the sensor.

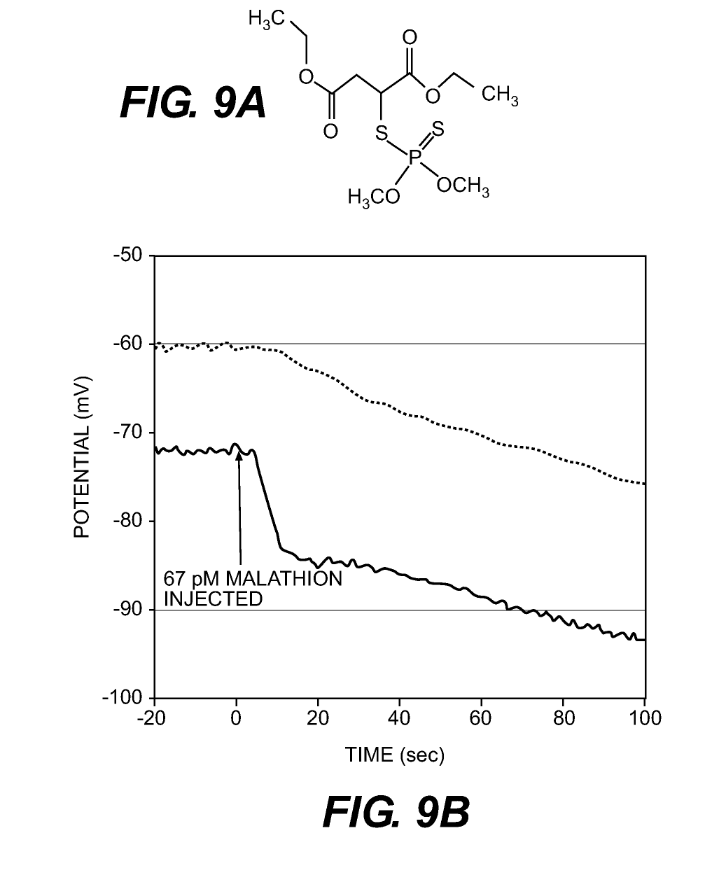

Although AA is a good OP simulant to evaluate and optimize the oxime-based sensor due to the fact that the chemical reactivity of AA is similar to that of OP CWA, the ultimate targets of the oxime-based sensor are OP CWA or OP pesticides. Therefore, in another embodiment of the invention, the oxime-based sensor was tested with an actual OP pesticide. FIG. 9B shows the potential response of the oxime-based sensor to malathion, one of the most widely used OP pesticide. Malathion is not harmful to humans at low exposure levels, but acts as a CWA when used on fish and insects. When about 67 pM malathion was injected at t=0 s into the PBO solution with CN ISE, the electrode potential dropped by about −10 mV, then slowly decayed with time. In a control experiment (dashed line in FIG. 9B) the same concentration of malathion was injected into the blank solution with no oxime, and the initial potential drop was not observed. Instead, the electrode potential slowly decayed with time at the same rate as in the presence of oxime. This indicates that the initial potential drop is due to the reaction of oxime and malathion, while the slow potential decay is due to a direct interaction between the electrode and malathion.

Malathion is known to be less reactive toward human AChE. Therefore, its reaction with oxime is also expected to be much less reactive than OP CWA or simulants. In addition, the malathion molecule contains two sulfur moieties, as shown in FIG. 9A. Because sulfur-containing molecules adsorb easily onto a variety of surfaces, malathion or its hydrolysis product might adsorb onto the electrode surface, interfere with the electrode response, and cause the observed potential tail.

In another embodiment of the invention, the oxime-based electrochemical sensor was tested with the several potential interferents including dimethyl methylphosphonate (DMMP), dowanol, and isopropyl acetate. DMMP is widely used as simulant for other OP sensors such as IMS and PFD because its chemical structure is similar to OP CWA but does not contain a leaving group. Therefore, it barely inhibits AChE and is much less toxic. When DMMP was tested in the oxime-based sensor, however, no changes in the electrode potential were observed, meaning that DMMP has negligible reactivity toward oxime. This indicates that the oxime-based sensor has a high enough selectivity high enough to discriminate even active and nonactive OP compounds. Similarly, dowanol was tested with the oxime-based sensor. In gas chromatography and IMS, the peak from dowanol often overlaps with those from OP compounds, making it difficult to resolve them. However, the oxime-based sensor gives no signal from dowanol. Isopropyl acetate also induced no response from the oxime-based sensor. These tests using potential interferents demonstrate the excellent chemical selectivity of the oxime-based sensor. Higher selectivity means less false positives in field applications, where many unknown chemicals are mixed with the target OP toxins.

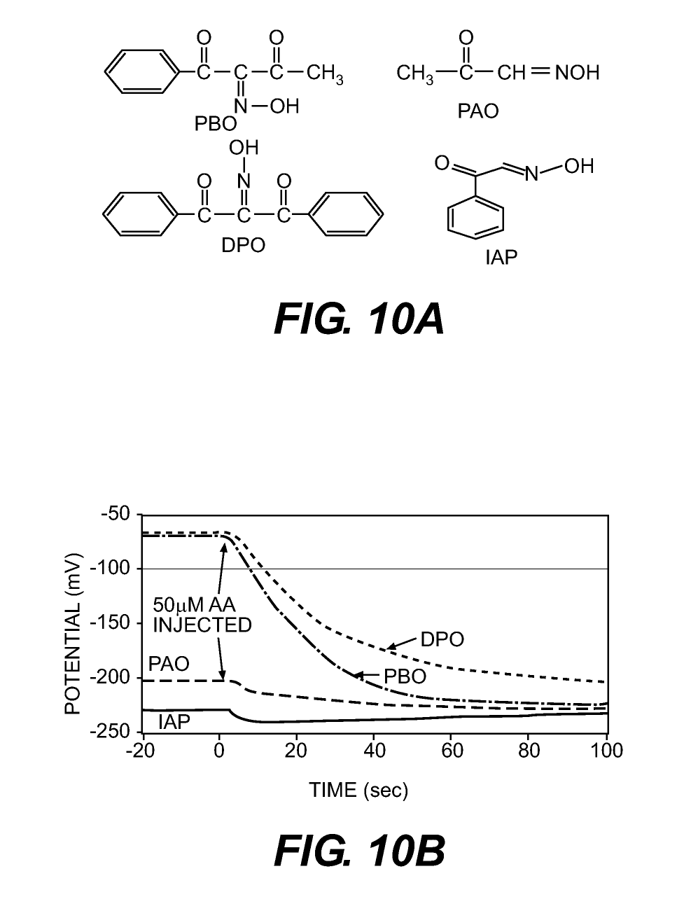

The chemical structure of the oxime-containing molecule has a large effect on the rate constant for the reaction between the oxime and the OP analyte. Therefore, oximes with different chemical structures were evaluated in the electrochemical sensor, in another embodiment of the invention. FIG. 10A shows the chemical structures of four different oxime-containing molecules tested: 1-phenyl-1,2,3,-butanetrione 2-oxime (PBO), 1,3-diphenyl-1,2,3-propanetrione 2-oxime (DPO), anti-pyruvic aldehyde 1-oxime (PAO), 2-isonitrosoacetophenone (IAP). PBO and DPO are diketooximes, while PAO and IAP are monoketo-oximes. FIG. 10B shows the potential response of CN ISE in different oximes. When about 50 pM AA was injected at t=0 s, the electrode potential decreased rapidly for about −50 s, reaching a constant potential of about 230 to about 210 mV, depending on the kind of oxime used. Initial potentials for monoketo-oximes PAO and IAP were about −200 and about −230 mV, respectively, which is much more negative than those for diketo-oximes PBO and DPO. This more negative initial potential reduces the potential range which can be utilized by the electrode, resulting in a lower sensitivity. The different initial potentials for different oximes may be rationalized by their acidity constants Kₐ. PAO has Kₐ of 10^{-8.3}, which is about one order lower than that for PBO, 10^{-7.1}. This means that the oximate anion of PAO has about 10 times higher affinity for a proton than the oximate anion of PBO. The higher proton affinity leads to a stronger interaction with the electrode surface, making the initial potential more negative. On the other hand, comparing the response curves of two diketo-oximes PBO and DPO, the PBO showed a larger potential change and faster kinetics. Thus, evaluation of four different keto-oximes concludes that the diketo-oxime PBO showed the most desirable performance.

Acidity of the oxime solution can also affect the response of the oxime-based sensor in several ways. If the pH is lower than acidity constant pKₐ for the oxime-containing molecules used, the oxime will not be activated into its anionic form, and the reaction rate will be much lower. Also, if the produced CN is turned into volatile HCN, the potential response will be smaller (pKₐ of HCN is 9.2). On the other hand, if the pH is too high, the hydrolysis of the OP analyte by hydroxide ion instead of the oximate anion will be faster and lead to a lower concentration of cyanide ion and a smaller potential response. Thus, the pH of the oxime solution must be optimized to achieve the highest level of detection of OP compounds.

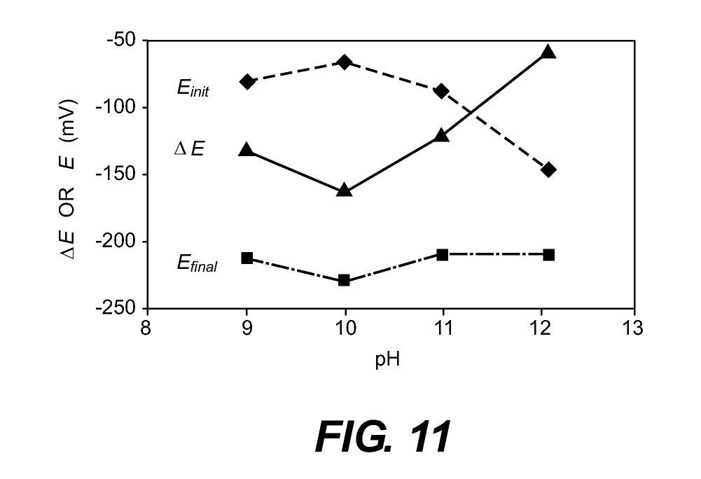

FIG. 11 shows an optimization experiment where the potential response of the oxime-based sensor in a range of solution pH. Initial electrode potentials (Eiₙᵢₜ) in an oxime solution exhibit strong dependence on solution pH. Eiₙᵢₜ becomes more negative at higher pH. In a control experiment, Eiₙᵢₜ in blank solution (without oxime) showed similar dependence on solution pH. Thus the pH dependence of Eiₙᵢₜ comes from the interaction of the electrode with the hydroxide ion rather than that with oxime. The final electrode potential (E_{final}) was the potential that the CN ISE reached after about 50 pM AA was injected into the oxime solution. E_{final} was less dependent on the solution pH, indicating that, as long as cyanide ion was present, the CN ISE was much less affected by the hydroxide ion. A slightly higher E_{final} at pH 9 was attributed to partial conversion of cyanide ion into HCN at this low pH. In terms of the potential difference (ΔE=E_{final}−Eiₙᵢₜ), the optimum pH was found to be about 10, at which most of the experiments in this paper were conducted. Note that ΔE was negative and the largest potential change at pH 10 is plotted as the most negative. However, it is understood that other pH levels may be used based on desired characteristics to be achieved.

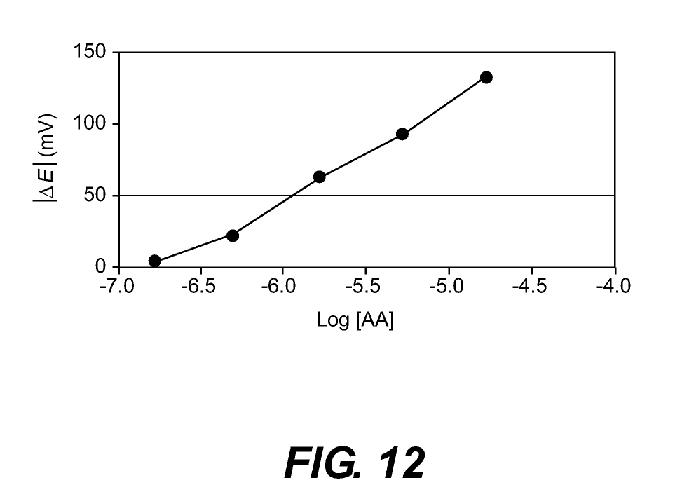

To construct the working curve of the oxime-based sensor and estimate the detection limit, the potential response of the sensor was measured in different concentrations of analyte. FIG. 12 shows the working curve for the oxime-based sensor, plotting the potential difference in a range of concentration of AA. The plot showed a good linear relation between AE and log [AA] in a wide concentration range between about 10^{-4 5} M and about 10⁻⁶M with slope of about 63 mV/decade. The slope in the working curve is very close to that in the calibration curve for CN ISE in Equation 3, indicating that the amount of cyanide ion produced is proportional to the amount of AA, as expected. At lower concentrations, AE approaches zero.

The detection limit was estimated to be about 5×10⁻⁷ M, or about 50 ppb, which corresponds to about −20 mV potential response. The detection limit of the oxime-based sensor is determined by two major factors. First, the CN ISE had its own detection limit of about 10⁻⁶ M, which sets the threshold cyanide ion concentration that is required to induce potential response. Second, the adsorption of anions, such as oximate anion, onto the electrode surface makes the initial electrode potential more negative. This more negative initial potential reduces the potential range that the electrode can utilize and makes the detection limit higher. Thus, if a cyanide ion sensor is developed that has much lower detection limit and has little interference by other anions, the detection limit of the oxime-based sensor would also be lowered.

An electrochemical oxime-based OP sensor was evaluated and optimized. The reaction of keto-oxime with an OP compound or acid anhydride simulant produces cyanide ion can be detected with cyanide ion selective electrodes. The oxime-based sensor gave the electrode potential response to active OP compound or its simulant. Cyanide is another CWA that can be detected with the sensor. This high chemical selectivity minimizes false positives in field applications. The experimental parameters, such as the oxime-containing molecules structure and the solution pH, for the oxime-based electrochemical sensor were optimized. Among the several keto-oximes evaluated, 1-phenyl-1,2,3-butanetrione 2-oxime (PBO) gave the largest response. The optimum pH for the oxime-based sensor was found to be pH 10. Interference of the electrode potential by other anions, such as oximate anion, is the major cause of lower sensitivity of the sensor. The detection limit of the current oxime-based sensor is estimated to be about 5×10⁻⁷ M, or about 50 ppb.

In another embodiment of the invention, actual AChE was tested in the microchannel sensor. Electric eel AChE (EC 3.1.1.7) and the OP agent, malathion (Aldrich) were used. Electric eel AChE is less expensive than human AChE and allowed the use of malathion as a CWA simulant.

Malathion vapor was sampled using a bubbler and argon carrying gas, from either the pure liquid or a sample diluted with ethanol. Acetylthiocholine chloride (Sigma Life Science, St. Louis, Mo.) was made to various concentrations in a phosphate buffer.

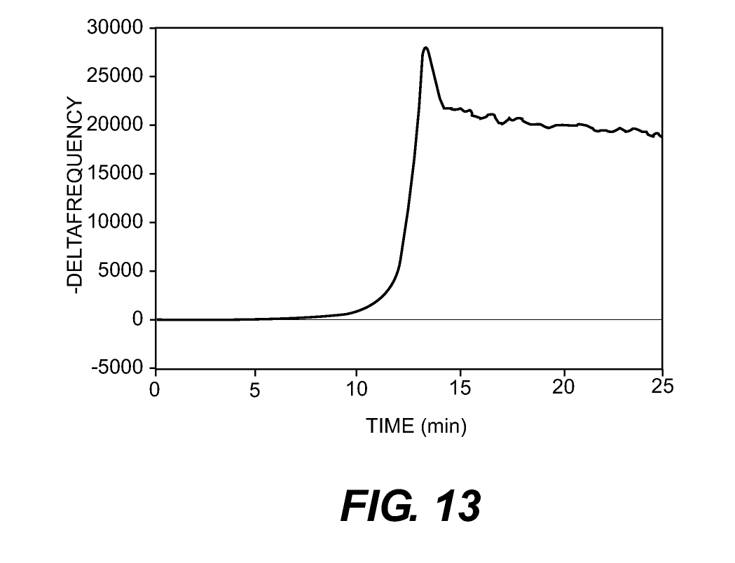

AChE was immobilized using the method of Carelli et al. (Carelli et al., “An interference-free first generation alcohol biosensor based on a gold electrode modified by an overoxidized non-conducting polypyrrole film,” Anal. Chim Acta 565 (2006), 27-35) for alcohol oxidase immobilization on a gold electrode. Glutaraldehyde and bovine serum albumin (BSA) (Aldrich) were used to immobilize AChE. The enzyme was cross-linked with BSA using liquid glutaraldehyde in order to form an immobilized gel: about 30 μL of gluteraldehyde was added to about 15 μL of about 314 U/mL AChE, about 8 mg BSA, and about 300 μL of phosphate buffer (pH=7.4). The solution (about 1 μL) was placed on the PDMS microchannel and allowed to dry for about 2 hours. FIG. 13 shows QCM data of this cross-linking. The negative delta frequency increases to a sharp peak, the gel point, and then decreases after drying.

AChE chemistry was first optimized in macro-scale experiments. The macro-scale experiments were used to optimize pH, determine degradation temperature, and test enzyme inhibition by malathion. A glassy carbon working electrode, platinum wire counter electrode, and standard Ag/AgCl reference electrode were used (Bioanalytical Systems, Inc). Acetylthiocholine (about 1 mM) was injected into the enzyme solution (about 2 U/mL in phosphate buffer) at various pH, temperature, and malathion concentrations. The system is incubated for 30 minutes and a cyclic voltammagram (CV) is run from about 0.0 to about 0.9 V vs. Ag/AgCl at a scan rate of about 100 mV/sec.

The acetylthiocholine solution is passed along the liquid microchannel, with or without immobilized acetylcholinesterase, using a syringe pump at 0.01 mL/min. The malathion vapor flows from an argon bubbler and through the gas-phase microchannel at about 10 mL/min. A conventional Ag/AgCl electrode (Bioanalytical Systems, Inc) was immersed in a small vial at the outlet of the liquid microchannel. The sensor is held at a constant potential of about 800 mV vs. Ag/AgCl and current is measured as the output of the system.

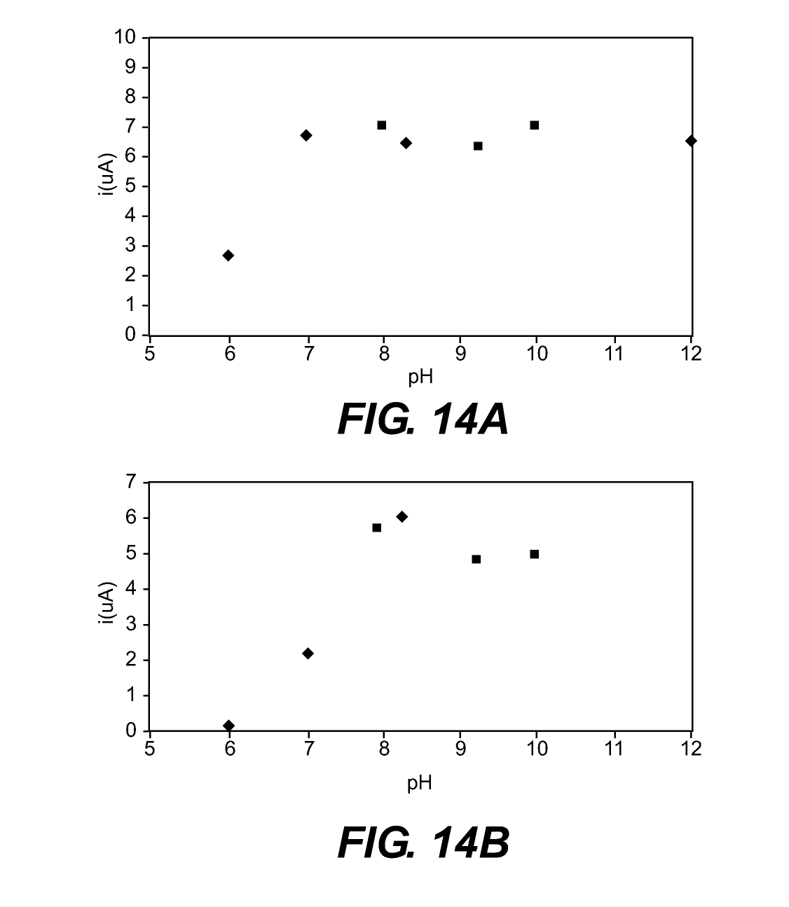

The effect of pH on acetylthiocholine hydrolysis is shown in FIGS. 14A and 14B. For both free and immobilized enzyme the current plateaus above a pH of about 7, showing a pH dependence only on the acidic side. At a pH of about 6, the current was considerably lower. This decrease in current occurred because of the histidine residue (pKa=6) in the active site of AChE is only slightly deprotonated at this pH.

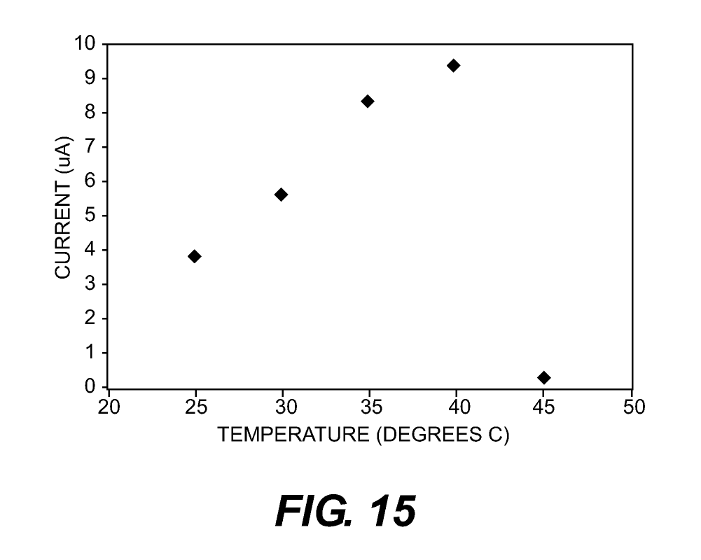

The degradation temperature of the enzyme was found by performing CVs on AChE solutions in a hot oil bath. FIG. 15 shows this decrease occurring between about 40 and about 45 degrees Celsius with an optimal temperature around 37 degrees Celsius. This data corresponds to previous work done by Rochu et al. and Silver (Rochu et al., “Thermal stability of acetylcholinesterase from Bungarus fasciatus venom as investigated by capillary electrophoresis,” Biochimica et Biophysica Bio Acta 1545 (2001) 216-226; Silver, “The Biology of Cholinesterases,” North-Holland, Amsterdam, 1974) documenting AChE behavior in both vertebrates and invertebrates.

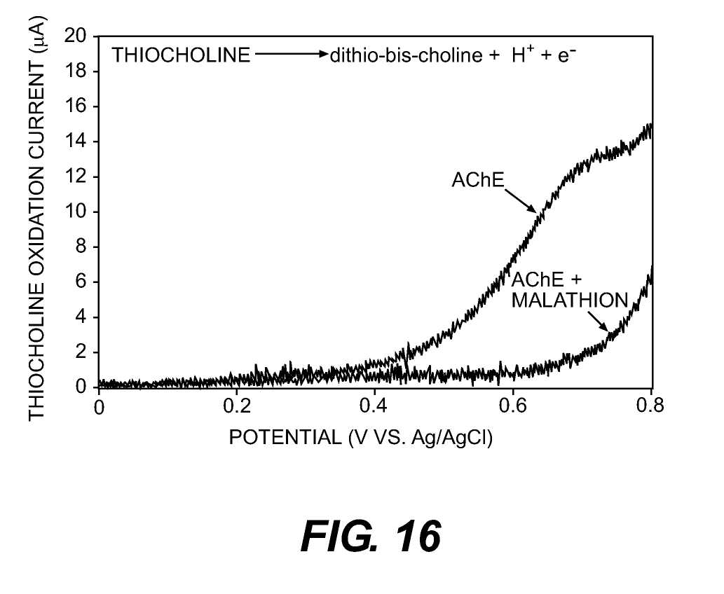

The results of the initial beaker cell inhibition experiments are shown in FIG. 16. Curve A shows the response of a solution of AChE and acetylthiocholine only. Curve B shows the response of a solution of AChE, acetylthiocholine after exposure to malathion. The solution containing malathion shows a decrease in current versus the solution without malathion. This decrease in current is due to the competitive inhibition of the AChE active site due to malathion. After exposure to about 23 mM malathion, the enzyme is 100% inhibited and thiocholine is no longer produced. Percent inhibition is calculated as [Iᵢₙᵢₜᵢₐₗ−I_{final}]/Iᵢₙᵢₜᵢₐₗ.

From the macro-scale experiments, it was found that a pH of about 7.4 and a temperature of approximately 25 degrees Celsius should be used to test our microchannel sensor. A pH of about 7.4 will give a strong current, while working at a temperature sufficiently below the degradation temperature will enhance enzyme stability. It was also determined, from beaker experiments, that malathion successfully inhibits electric eel AChE and can be used as a less toxic CWA simulant for microsensor testing.

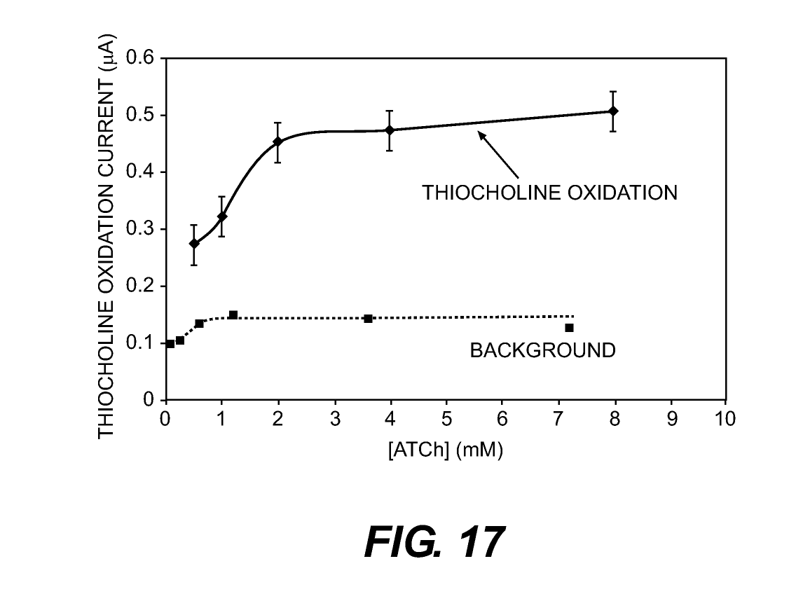

The response of the microchannel sensor to different acetylthiocholine concentrations is shown in FIG. 17. The liquid channel contains immobilized AChE (about 14 U/mL). Acetylthiocholine solution flows across the immobilized enzyme at a flow rate of about 0.01 mL/min. In the low concentration region, there is a linear increase in current. Above a concentration of about 2 mM, there is negligible current increase and the enzyme catalyst becomes saturated. In FIG. 17, the hollow squares correspond to the oxidation of unhydrolyzed acetylthiocholine as a control. Although acetylthiocholine is also slightly electrochemically active, the data shows that acetylthiocholine produces only a small, steady background that does not vary with concentration.

Overall, at least four design parameters may affect the response of the sensor to acetylthiocholine and malathion: 1) Location of the counter electrode with respect to the working electrode; 2) the difference in sensor response due to both free and immobilized enzymes; 3) sensor response due to location of the immobilized enzyme; and 4) response of the sensor to simulants and interferences.

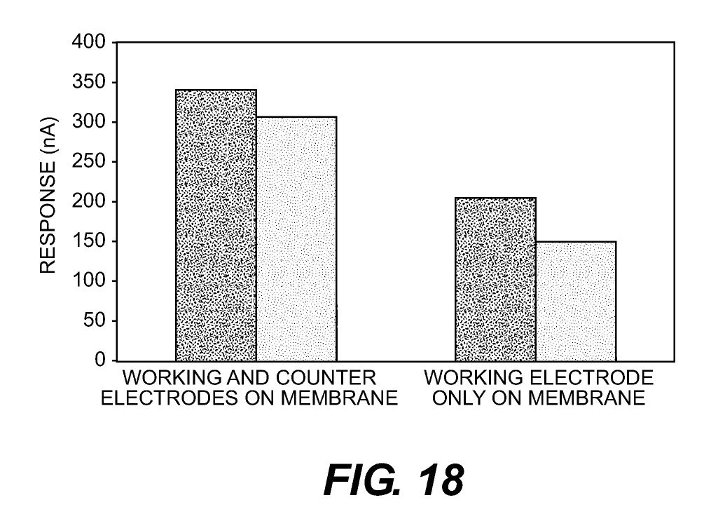

Amperometric measurements require both a working and counter electrode. When working with such small concentrations, it is often difficult to eliminate IR drop between the working and counter electrodes. The response of the sensor to placement of the counter electrode is shown in FIG. 18. There is a higher current response seen when the counter electrode is placed on the nanoporous membrane with the working electrode. This increase in response indicates that there is a drop in current when the counter electrode is placed at a distance from the working electrode. To eliminate the reduction in current, all further experiments were carried out with the working and counter electrodes on the nanoporous membrane.

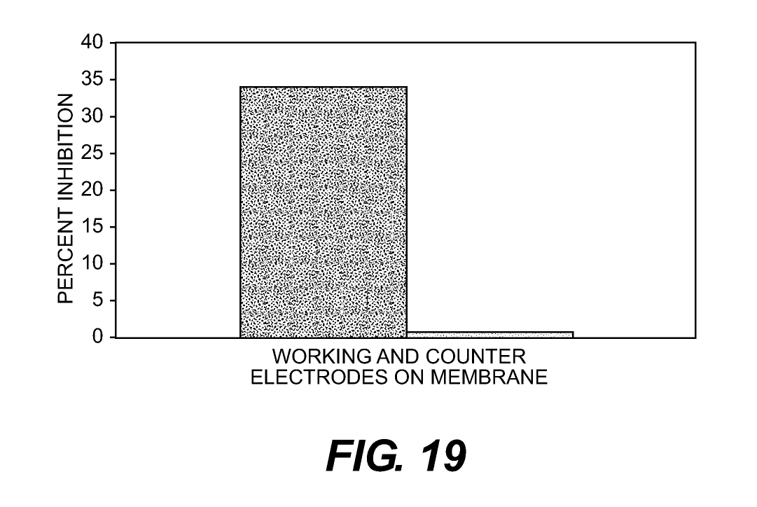

The data shown in FIG. 18 also indicates that there is little change in sensor response to acetylthiocholine due to immobilization of AChE. Given that the enzyme activities were the same for the free and immobilized AChE, a large difference in sensor response was not expected. When the sensor was exposed to malathion, however, the immobilized enzyme showed a larger percent inhibition than the free enzyme in solution. Percent inhibition was calculated as the current before malathion exposure minus the current after malathion exposure divided by the initial current. The immobilized AChE showed about a 33% inhibition when exposed to about 52 ppb malathion. Conversely, the AChE in solution was only inhibited about 0.6 percent. Comparison data is shown in FIG. 19.

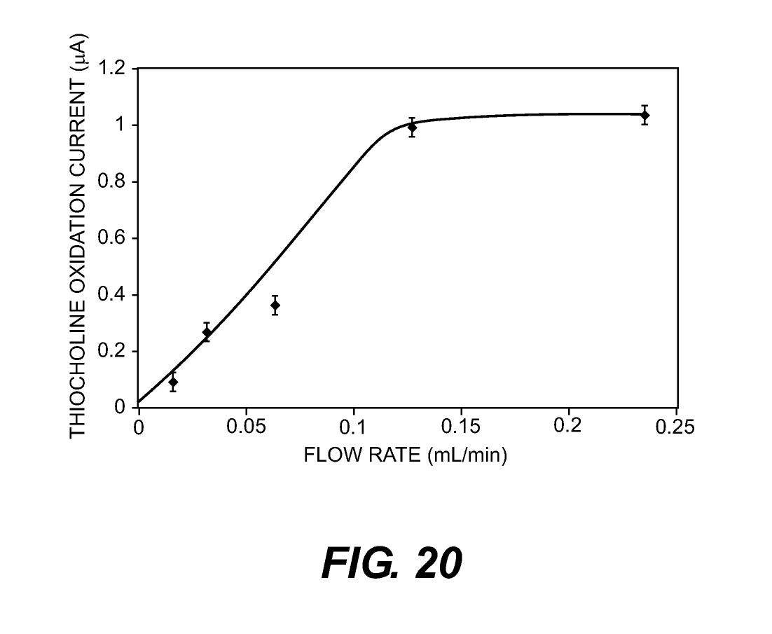

Due to the role of AChE in the very rapid process of nervous transmission, AChE reacts extremely rapidly with a particularly high rate of activity. Therefore, the hydrolysis of ATCh is rate limited by substrate diffusion to the AChE active site. In order to maximize the mass transfer in the microchannel, the response of the microchannel sensor at various liquid flow rates of ATCh solution is measured. FIG. 20 shows the sensor response to various liquid flow rates. The liquid channel contains about 18 U/mL immobilized AChE with about 4 mM of acetylthiocholine in solution. The sensor response is reported after subtracting out the background from acetylthiocholine and phosphate buffer. There is a linear increase in response, due to increasing liquid flow rate, until approximately about 0.13 mL/min. At liquid flow rates higher than about 0.13 mL/min, the response reaches a plateau. The optimum flow rate of ATCh liquid was determined to be about 0.13 mL/min, above which the sensor response is not limited by mass transfer.

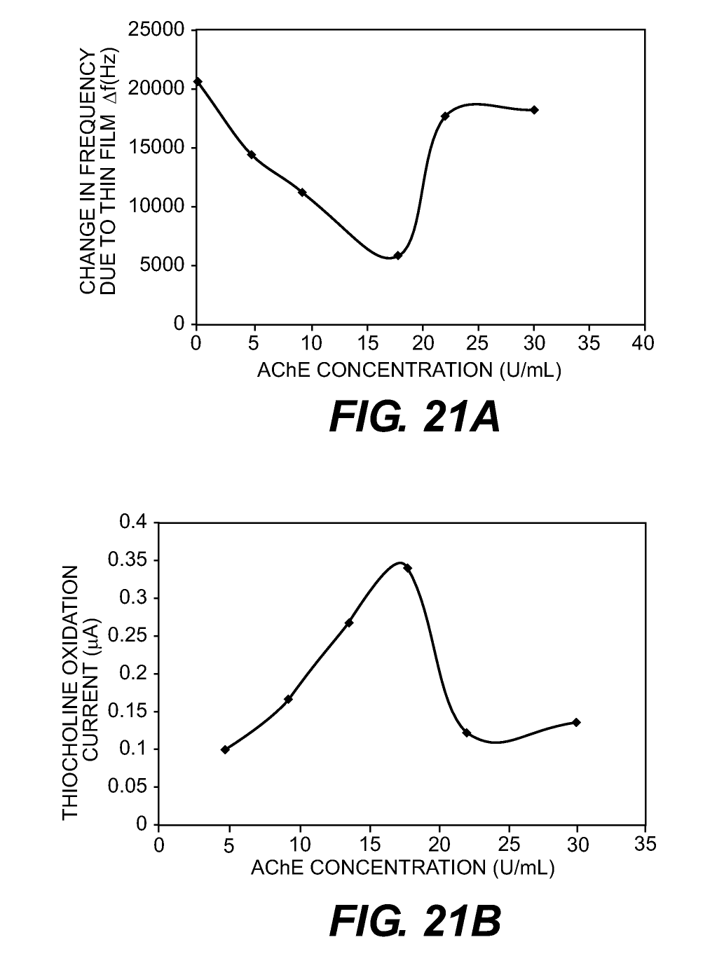

FIGS. 21A and 21B show the effect of varying the concentration of AChE in the gel on both −Δf and thiocholine oxidation current. In FIG. 21A, it can be seen that for up to 18 U/mL of AChE that −Δf decreases linearly, as the amount of AChE in the gel increases. However, above about 18 U/mL of AChE −Δf increases abruptly due to an increase in density and/or viscosity. This result is consistent with the data found by previous researchers for the Δf of polyethylene glycol gels as a function of weight percent polyethylene glycol. To compliment this finding, in FIG. 21B, the oxidation current initially increases linearly with the concentration of AChE in the gel until about 18 U/mL AChE. Beyond this, thiocholine oxidation current drops dramatically because the increase in density and/or viscosity of the gel prevents the acetylthiocholine from reaching the AChE active site. As a result, from FIGS. 21A and B it can be seen that a condition resulting in a minimum density and/or viscosity of the gel about (18 U/mL) corresponds to maximizing the thiocholine oxidation current. The increase in the current due to the decreasing density/viscosity demonstrates that more dense gels slow down the ATCh diffusion to the AChE active site, whereas less dense gels allow for ATCh to be transported more easily to the active site. Therefore, it is determined that the optimum amount of AChE in the cross-linked gel can be contained with about 18 U/mL AChE solution.

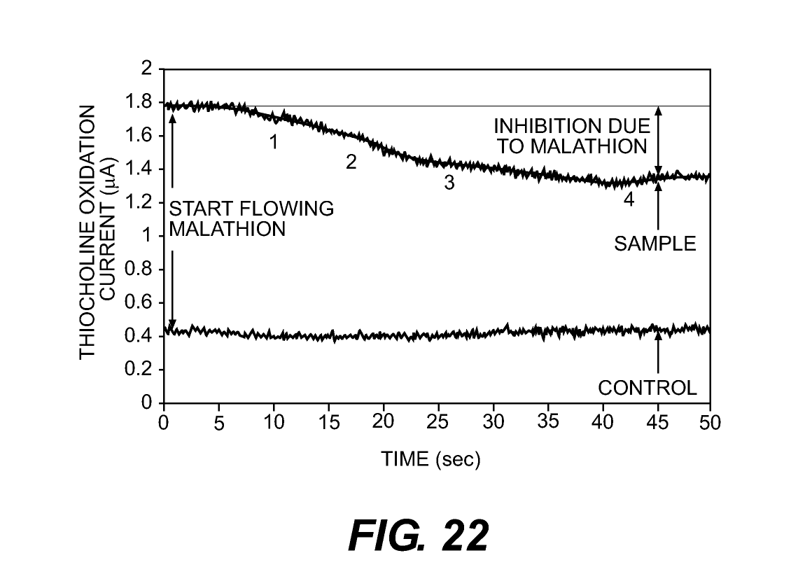

In another embodiment of the invention, the dual microchannel design was tested with eel AChE. FIG. 22 demonstrates that the dual microchannel/membrane design can be used as a fast sensitive sensor. There was about a 25% inhibition of AChE when the sensor is exposed to about 0.2 ppb malathion. The response curve contains multiple saturation steps, due to the four active sites of the AChE enzyme. The mass transfer of the gas molecules into the liquid microchannels was efficient; FIG. 20 shows that a measurable response occurred in just a few seconds. It took almost 40 seconds for all four active sites to become saturated, which is an improvement over the response time of 10 minutes found by previous authors for ppb detection limits of OP pesticides using AChE.

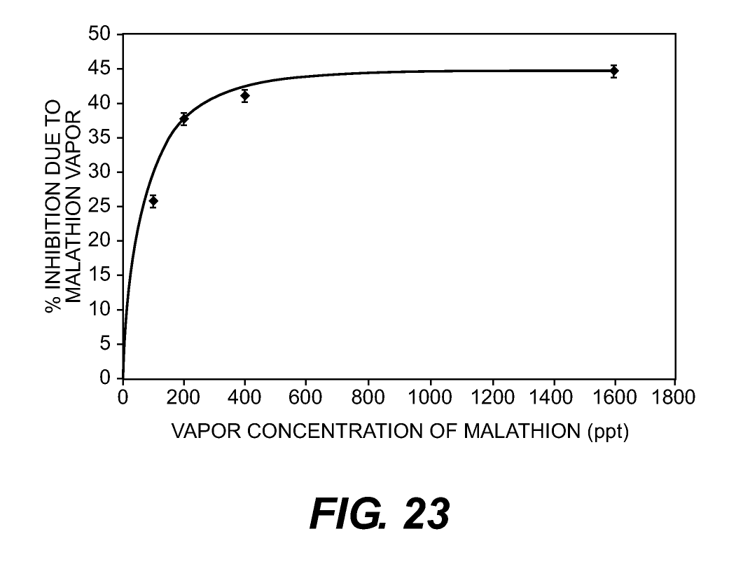

The detection limit for the sensor was determined by testing sensor response at decreasing malathion concentrations until the signal to noise ratio was approximately three. FIG. 23 shows the effect malathion concentration has on percent inhibition. Malathion vapor was supplied to the sensor at a flowrate of 10 mL/min. The liquid microchannel contained about 4 mM acetylthiocholine at a flow rate of about 0.128 mL/min over the immobilized enzyme (about 18 U/mL AChE in cross-linked solution). The sensor response becomes saturated at around 44% inhibition and the detection limit of the sensor is about 100 ppt where the signal to noise ratio is equal to three.

The use of the dual microchannel/membrane reactor allowed for fast diffusion of a concentrated vapor into the liquid microchannel and lowered the detection limit and detection time, compared to previous methods. Using electric eel AChE gave the sensor a higher level of selectivity than previous sensors; only OP agents that inhibit the enzyme will give a response. Also, using a microscale sensor allows the system to be completely portable.

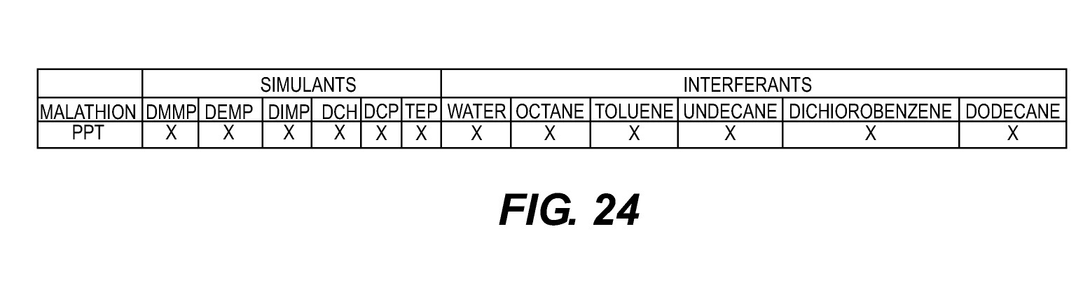

In another embodiment of the invention, the sensitivity of the sensor to various OP agents was tested. It was found that the sensor tested is sensitive only to the OP agents, which have shown in vivo toxicity by modulating the AChE pathway. FIG. 24 is a table that illustrates the response of the sensor to a variety of OP simulants and common interferences. Organic solvents, such as toluene and dodecane, did not produce a response. Also, molecules with similar chemical structures to the toxic OP agents did not inhibit the AChE sensor. For example, the sensor did not produce a response when exposed to DMMP, which has similar chemical structure to sarin gas. This selectivity results from using the actual enzyme, which is sensitive to such toxic agents in the body. Hence, only those agents will show a response. Conventional methods, such as GC/MS and IMS, are not capable of detecting the relative toxicity of OP agents. This selectivity of the sensor is crucial for real-life OP sensor applications.

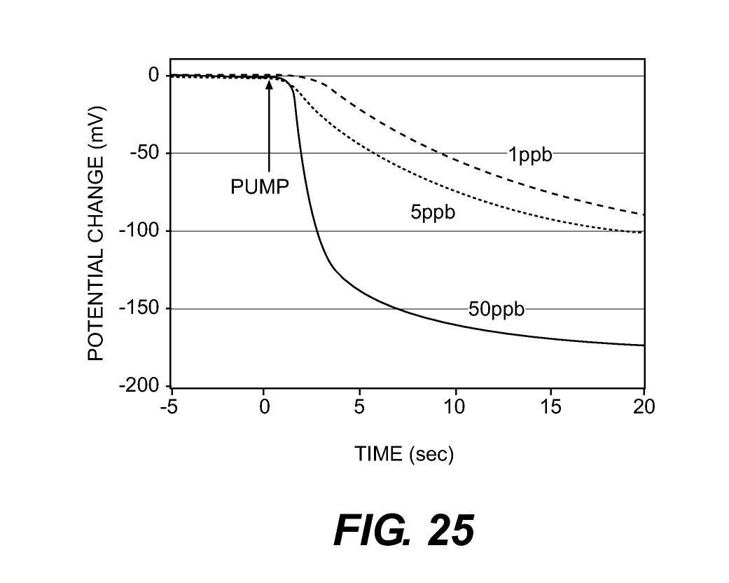

FIG. 25 shows the response from the microsensor according to another embodiment of the invention. At t=0 s, a dilute AA vapor was pumped to the sensor at a flow rate of about 100 mL/min. As the sample gas moved through the membrane and reacts with the oxime solution, the produced cyanide ion in the thin layer makes the electrode potential negative. The more dilute the sample gas is, the slower the potential changes. With about 1 ppb AA gas vapor, it took about 10 seconds to induce about a 50 mV potential change, which much faster than the response from the beaker cell.

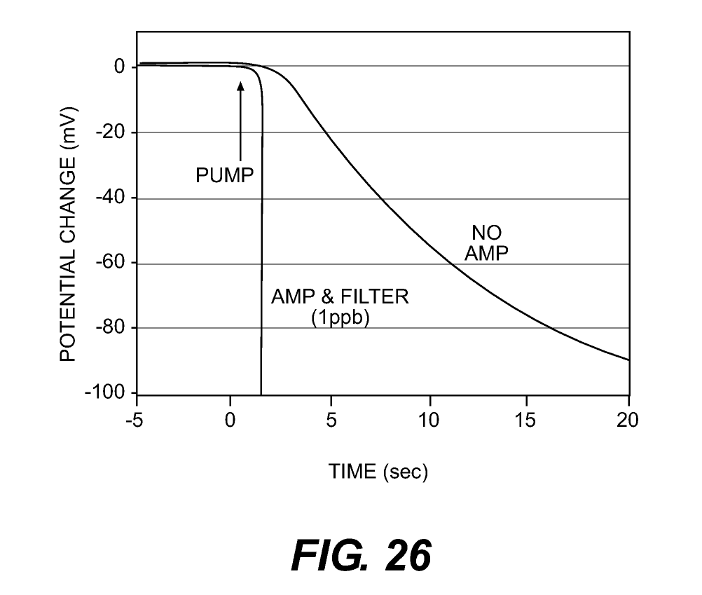

FIG. 26 shows that the detection time can be further decreased using an amplifier and a filter. A low-pass filter and an instrumental amplifier were connected to the output from the working electrode and the initial potential with respect to the reference electrode was offset to 0. With amp gain of about 20, the sensor gives about 100 mV response to 1 ppb AA gas sample within less than 2 sec.

According to another embodiment of the invention, a microchannel sensor system may be designed based on various parameters. The assembly of the microchannel sensor may involve three steps: 1) fabrication of micro-channels, 2) deposition of the electrode onto a nanoporous membrane, and 3) assembly of the gas and liquid micro-channels and the nanoporous membrane. The micro-channels may be machined into a small polycarbonate block. To make the membrane coated with an electrode, track-etch polycarbonate membrane of various pore size (thickness 10 μm; SPI) may be sputtered with a 40-nm thick layer of gold on the side of the liquid micro-channel. Some track-etch membranes are purchased with a hydrophilic poly(vinyl pyrollidone) (PVP) coating. The gas microchannel may be made to overlap the liquid microchannel. The membrane may be sandwiched between the two polycarbonate micro-channels and the assembly is clamped using 5 screws. The assembly may look similar to the embodiments illustrated in FIGS. 2A-2E.

An oxime solution of about 10 mM 1-phenyl-1,2,3,-butanetrione 2-oxime (PBO, Aldrich) in a borate buffer (pH=10) may be used. Because oxime-containing molecules degrade and loses reactivity over several days, fresh oxime solution is prepared for every experiment. The chemical vapors, which are passed along the gas microchannel, are sampled with a syringe from pure liquid chemicals in a bubbler and diluted with ambient air to the desired vapor concentration.

The testing set-up of the oxime sensor may be performed by passing the oxime solution along the liquid micro-channel using a manually-operated syringe. During electrochemical measurements, the liquid in the micro-channel remains static. After each measurement, fresh oxime solution is passed through the liquid micro-channel in order to remove reaction products present in the sensor. The vapor sample is introduced into the gas microchannel using a syringe pump containing the diluted chemical sample at the flow rate of about 1 mL/min. A conventional Ag/AgCl reference electrode (Bioanalytical Systems, Inc) is immersed in the vial that is connected to the outlet of the liquid microchannel. The open-circuit potential between the membrane electrode and the reference electrode is measured as the output signal from the micro-channel sensor. By measuring the electrode potential of a gold electrode in diluted standard cyanide ion solution, the Nerntian equation in the CN−concentration range of about 10⁻⁴ to about 10⁻⁵ M is determined to be:

E=−0.73−0.12 log [CN−] (4)

where E is the open-circuit potential in volts with respect to the Ag/AgCl reference electrode. Open circuit potential was measure at various channel geometry, membrane pore size, and pore hydrophilicity.

A numerical simulation of cyanide ion concentration in the liquid micro-channel and organophosphate concentration in the vapor micro-channel was performed over a range of channel geometry, membrane pore size, and pore hydrophilicity using COMSOL Multiphysics 3.3 and the Chemical Engineering Module. The vapor and liquid micro-channels can be considered two-dimensional and possessing fluidics which are incompressible and low-Reynolds number. There is no flow parallel to the membrane in the liquid micro-channel and only diffusive transport perpendicular to the membrane is considered in the liquid micro-channel and through the membrane itself. As noted above, a simple two-dimensional model of the vapor and liquid micro-channels is shown in FIG. 2A.

The general diffusion equation is

$${u}_{x} \frac{\partial C}{\partial x} + {u}_{y} \frac{\partial C}{\partial y} - D \frac{{\partial }^{2} C}{\partial {y}^{2}} - R = \frac{\partial C}{\partial t} \qquad ( 5 )$$

Where C is concentration, D is diffusivity, R is the reaction rate and u is velocity. For organophosphorous molecules in the gas microchannel, there is no flow perpendicular to the membrane and no reaction occurring. Therefore the convective transport term in the y-direction and the reaction rate can be neglected. As the organophosphorous molecules travel through the nanoporous membrane and into the stagnant liquid microchannel all convective transport terms can be neglected. Again, there is no reaction of the organophosphorous molecules in the porous membrane and the reaction rate can be neglected. When the organophosphorous molecule reaches the liquid microchannel, it reacts with oxime solution to form cyanide ions. The reaction rate in the liquid microchannel follows second-order kinetics with respect to the concentrations of oxime and phosphate in solution. The resulting mass-transport equations are

$${u}_{x} \frac{\partial {C}_{P , air}}{\partial x} - {D}_{P , air} \frac{{\partial }^{2} {C}_{P , air}}{\partial {y}^{2}} = \frac{\partial {C}_{P , air}}{\partial t} \qquad ( 6 )$$

### Transport of Organophosphorous in Gas Microchannel

$$- {D}_{p , membrane} \frac{{\partial }^{2} {C}_{P , membrane}}{\partial {y}^{2}} = \frac{\partial {C}_{P , membrane}}{\partial t} \qquad ( 7 )$$

### Transport of Organophosphorous Through Nanoporous Membrane

$$\begin{matrix} - {D}_{p , liquid} \frac{{\partial }^{2} {C}_{P , liquid}}{\partial {y}^{2}} - {k}_{1} {C}_{P , liquid} {C}_{oxime , liquid} = \frac{\partial {C}_{P , liquid}}{\partial t} & ( 8 ) \\ - {D}_{oxime , liquid} \frac{{\partial }^{2} {C}_{oxime , liquid}}{\partial {y}^{2}} - {k}_{1} {C}_{P , liquid} {C}_{oxime , liquid} = \frac{\partial {C}_{oxime , liquid}}{\partial t} & ( 9 ) \\ - {D}_{C , liquid} \frac{{\partial }^{2} {C}_{C , liquid}}{\partial {y}^{2}} + {k}_{1} {C}_{P , liquid} {C}_{oxime , liquid} = \frac{\partial {C}_{C , liquid}}{\partial t} & ( 10 )\end{matrix}$$

### Transport and Reaction of Organophosphorous, Oxime, and Cyanide Ion in Liquid Microchannel

Where C is the concentration, D is the diffusivity, ux is the velocity of organophosphorous molecules parallel to the membrane, and k1 is the kinetic constant.

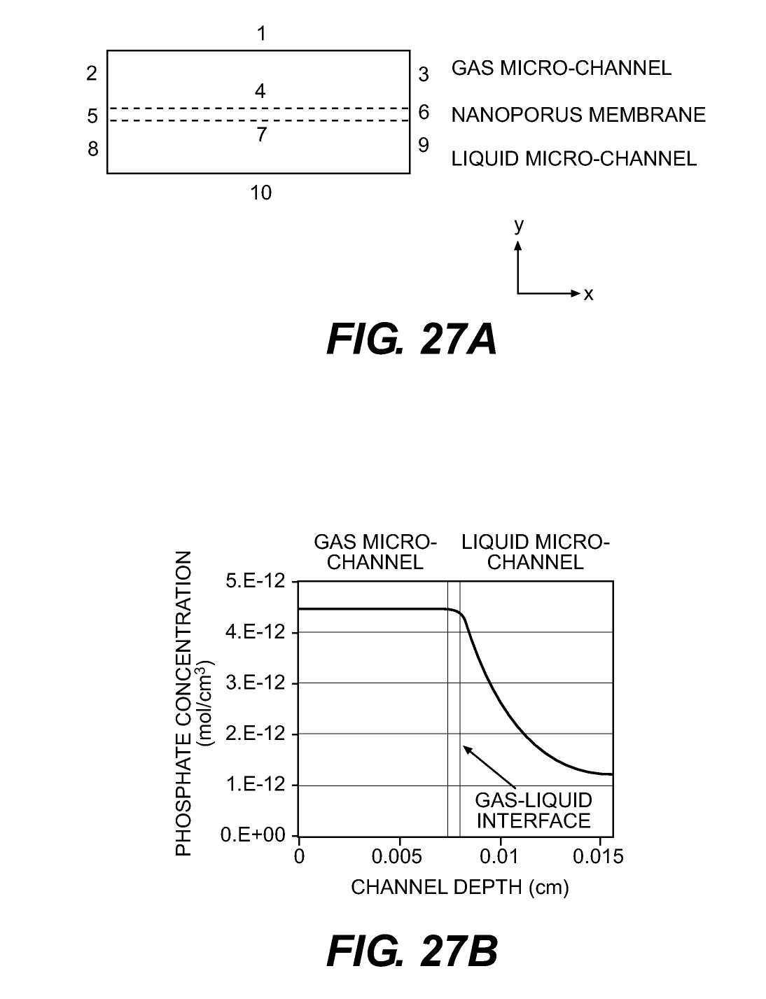

Ten boundary conditions are needed for the five second-order partial differential equations. Table 1 lists the conditions at each boundary for COMSOL simulation of multiphase micro-reactor. The boundary numbers can be found in the schematics of FIG. 27A. Boundaries 1, 5, 6, and 10 provide for zero flux along the channel wall and boundaries 3 and 9 allow for constant flux across the interface. The boundaries at the nanoporous membrane (4 and 7) state that there is constant flux at the membrane surface with no discontinuity in concentration.

TABLE 1

| Boundary | Boundary Condition | Boundary Type |
|---|---|---|
| 1 | \vec{n} · (−D∇C + C\vec{u}) = 0 | Insulation/symmetry |
| 2 | C = C_{bulk} | Concentration |
| 3 | \vec{n} · (−D∇C) = 0 | Convective flux |
| 4 | \vec{n} · \vec{N} = N₀; \vec{N} = −D∇c1 + c1\vec{u} | Flux |
| 5 | \vec{n} · (−D∇C + C\vec{u}) = 0 | Insulation/symmetry |
| 6 | \vec{n} · (−D∇C + C\vec{u}) = 0 | Insulation/symmetry |
| 7 | \vec{n} · \vec{N} = N₀; \vec{N} = −D∇c1 + c1\vec{u} | Flux |
| 8 | C = 0 | Concentration |
| 9 | \vec{n} · (−D∇C) = 0 | Convective flux |
| 10 | \vec{n} · (−D∇C + C\vec{u}) = 0 | Insulation/symmetry |

The constants used in the simulation can be found in Table 2. Air and liquid diffusion coefficients of Dgas=0.01 cm²/sec and Dliquid=1×10-5 cm²/sec were used.

TABLE 2

| Name | Expression | Description |
|---|---|---|
| k | 5.79 × 10³ | Approximate |
| | | reaction constant |
| | | (cm³mole⁻¹min⁻¹) |
| D_{gas} | 0.01 | Diffusivity of |
| | | vapor-phase |
| | | molecules |
| | | (cm²/sec) |
| D_{liquid} | 1 × 10⁻⁵ | Diffusivity of |
| | | liquid-phase |
| | | molecules |
| | | (cm²/sec) |
| C_{initial, oxime} | 1 × 10⁻⁵ | Initial |
| | | concentration of |
| | | oxime in solution |
| | | (mol/cm³) |
| Cₚₕₒₛₚₕₐₜₑ | 4.5 × 10⁻¹² | Concentration of |
| | | phosphonate |
| | | vapor (mol/cm³) |

The diffusivity of organophosphorous vapor through a hydrophobic membrane, Dm, was estimated using a model for gas diffusion in porous media.

Dₘ=D_{gas}ε^{4/3}

where ε is the porosity of the nanoporous membrane. The value of ε varies with respect to pore size by:

$$ɛ = \frac{n ( \frac{π \cdot {d}^{2}}{4} )}{w \cdot l} \qquad ( 12 )$$

where n is the number of pores, d is pore diameter, w is channel width, and I is channel length. When simulating transport through PVP-coated, hydrophilic pores, it is assumed that the pores are wicked with liquid. In this case, Dliquid is used in Equation 7 in place of Dgas.

The superficial velocity of the organophosphorous vapor varies with channel geometry by:

$${u}_{x} = \frac{Q}{w \cdot h} \qquad ( 13 )$$

where Q is the flow rate of the organophosphorous vapor (about 1 cm³/min), w is the channel width, and h is the channel height.

The concentration of organophosphorous vapor (about 4.5×10-5 mol/cm³) and initial concentration of oxime solution (about 1×10⁻⁵ mol/cm³) were taken from the experimental procedure. The reaction rate follows a second-order rate law with respect to oxime and organophosphorous concentration and has a rate constant (k) of about 5.79×10³ cm³ mole-¹ min⁻¹.

FIG. 27B is a graph show simulation results for the organophosphorous concentration profile along the depth of an embodiment of the microreactor. In this embodiment, the micro-channels are about 0.0075 cm deep and are separated by about a 0.0006 cm thick membrane and the concentration profile is taken at a position halfway down the length of the microreactor (about 0.25 cm) after about 90 seconds. The nanoporous membrane contains pores that are about 50 nm in diameter and are considered hydrophobic. There is only a slight concentration gradient in the gas microchannel and across the nanoporous membrane. Organophosphorous enters the micro-reactor at about 4.5×10⁻¹² mol/cm³ and the gas-liquid interface is saturated with organophosphorous vapor. When the organophosphorous enters the liquid micro-channel and begins to react with oxime solution, there is a large concentration gradient.

FIG. 27B shows the organophosphorous concentration profile along the depth of a sensor system of the invention as found from the COMSOL simulation. The liquid micro-channel contains about 10 mM oxime solution with about a 100 ppb analyte gas at a flow rate of about 1 cm³/min in the vapor micro-channel. In the gas micro-channel and across the nanoporous membrane there is only a slight organophosphorous concentration gradient. This result suggests that the gas-liquid interface is always saturated with organophosphorous vapor. When the organophosphorous molecules cross the gas-liquid interface, however, there is a large concentration gradient. This is due to the decreased diffusion of the organophosphorous molecules, as compared to diffusion in the gas micro-channel, and the reaction of the organophosphorous molecules with the oxime solution.

The simulation was then used to vary multiple geometric reactor parameters, in order to determine the effect each parameter had on sensor response. Table 3 shows the simulation results. After varying the width and length of the micro-channels, simulation results found that there was no effect on the sensor response. Changing parameters such as channel depth, pore size, and pore hydrophilicity, however, were found to have a large effect on sensor response. Pore hydrophilicity was found to have the greatest effect on response, and moving from hydrophilic to hydrophobic pores increases the cyanide ion concentration in the liquid microchannel by a factor of about 17.

Specifically, increasing pore size by a factor of about 10 has a slight effect on sensor response, while decreasing the channel depth by a factor of two and making the pores hydrophobic has the largest effect on sensor response.

TABLE 3

| Geometric | Magnitude | Increase |
|---|---|---|
| Parameter | of Change | in Response |
| Channel length | 3.33 | 0 |
| Channel width | 4 | 0 |
| Channel depth | 0.25 | 3.1 |
| Pore size | 10 | 1.4 |
| Pore | Hydrophilic to | 100 |
| hydrophilicity | hydrophobic | |

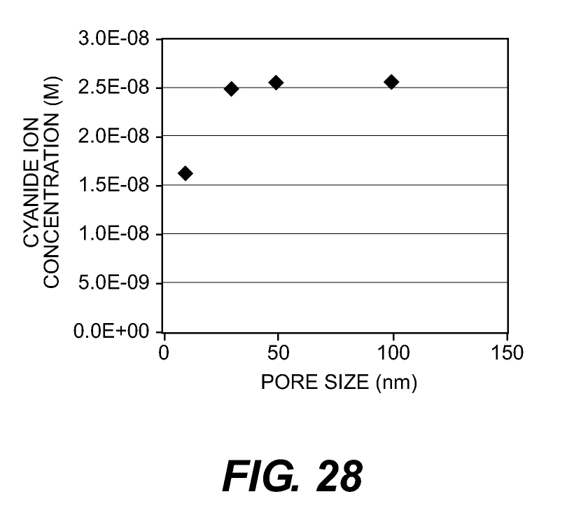

FIG. 28 is a graph showing simulation results for the effect of pore size in the nanoporous membrane on sensor response. Cyanide ion concentration reported is for a microchannel that is about 0.25 mm wide, about 0.1 mm deep, and about 5 mm long after a time of about 30 seconds. The liquid micro-channel contains about 10 μM oxime solution with about 100 ppb analyte gas at a flow rate of about 1 cm³/min in the vapor micro-channel and the cyanide ion concentration is measure after about 30 seconds. The simulation results show that with an increase in pore size from about 10 nm to about 100 nm there is an increase in sensor response in the form of an increase in cyanide ion concentration. This result indicates that the mass transfer through the pore is faster with larger pores, leading to a faster response. The mass-transport increases due to an increase in open surface area and therefore porosity (Equation 12) of the nanoporous membrane with an increase in pore diameter. The larger open surface area increases the gas-liquid interface and allows more organophosphorous molecules to cross into the liquid microchannel.

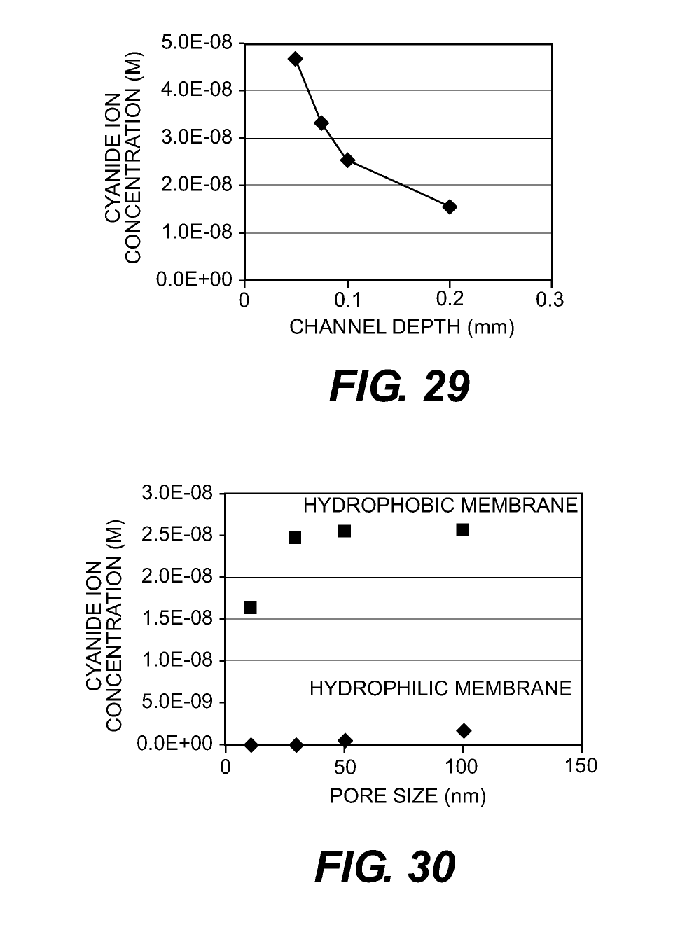

FIG. 29 shows the effect of channel depth on sensor response from the COMSOL simulation. The micro-channels in this example are about 0.25 mm wide and about 1 cm long with about 50 nm pores in the nanoporous membrane. The pore density is constant for all pore size in both simulation and experiment. The liquid micro-channel contains about 10 mM oxime solution with 100 ppb analyte gas at a flow rate of about 1 cm³/min in the vapor micro-channel. The sensor response was measured after 30 seconds. As the channel depth decreases from about 0.2 to about 0.05 mm, the sensor response increases in the form of increased cyanide ion concentration. The increase in response may be due to a build up of cyanide ions or organophosphorous molecules near the gas-liquid interface for the smaller channel depths because there is a smaller amount of liquid for the ions to diffuse into.

FIG. 30 shows simulation results of the effect of membrane hydrophilicity on sensor response. The micro-channel was set at about 0.25 mm wide, about 0.075 mm deep, and about 5 mm long and the cyanide ion concentration was reported at a time of 30 seconds. The liquid micro-channel contains 10 μM oxime solution with about 100 ppb analyte gas at a flow rate of about 1 cm³/min in the vapor micro-channel and the cyanide ion concentration is measure after 30 seconds. The simulation results show that a hydrophobic nanoporous membrane has a sensor response that is almost two orders of magnitude larger than a hydrophilic membrane. This result is due to the filling of the hydrophilic pores with oxime solution. The diffusivity of the membrane decreases by Equation 11, when the pores are wicked with solution. This decrease in diffusivity leads to slower diffusion times by:

Equation 14

Δx=√\vec{2Dt} (14)

where Δx is displacement of diffusion front, D is diffusion coefficient, t is time. When the diffusion time is decreased, the sensor response time also decreases.

The calculations above were done with the gas and liquid microchannels having the same depth, however the calculations show that the depth of the gas microchannel has very little effect on the response. Physically, the response is kinetic or mass transfer limited within the liquid solution. Calculations indicate that the depth of the gas microchannel does not substantially affect the response when the depth of the gas microchannel is no more than the depth of the liquid microchannel multiplied by the square root of ratio of the diffusivities of the analyte in the gas and liquid. For the example in table 2, the ratio is 1000, so that the depth of the gas microchannel could be 32 times the depth of the liquid microchannel with no effect. Specifically, if the liquid channel were 0.25 mm deep, the gas channel could be 8 mm deep.

After analysis of the COMSOL simulation results in Table 3, a design of experiments was completed based on the simulated data. From the simulation results, it was noted that varying channel length and channel width did not have a large effect on sensor response. Varying channel depth, pore size, and pore hydrophilicity, on the other hand, have a larger effect on sensor response. Therefore, testing of the oxime microreactor focused on changing channel depth, pore size, and membrane coatings to determine the effect of each on sensor response.

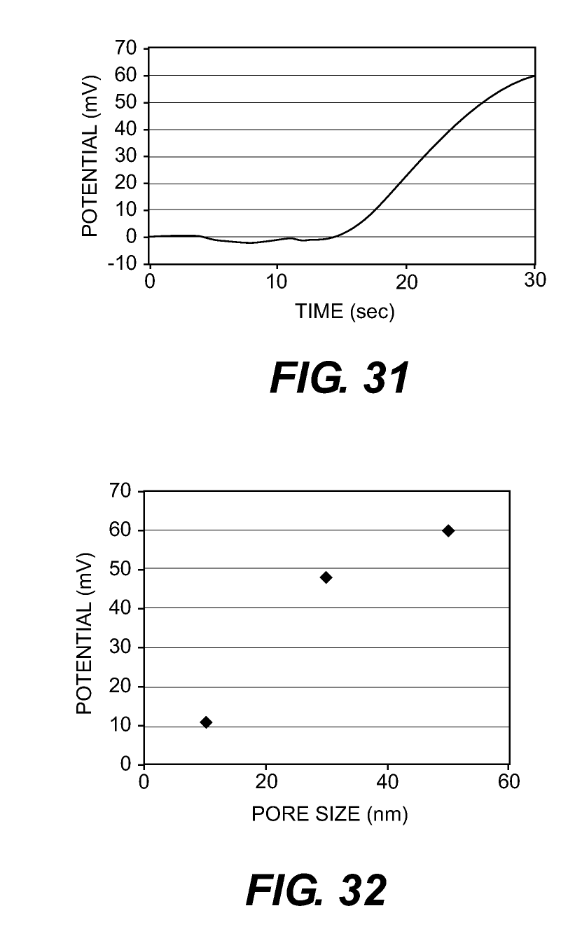

FIG. 31 shows experimental results for the response of an oxime microreactor to organophosphorous vapor. The liquid micro-channel is about 0.05 mm wide, about 0.25 mm deep, and about 5 mm long contains about 10 mM oxime solution in borate buffer (pH=10). Those skilled in the art know that other buffers also could be used instead including for example CAPS (3-(Cyclohexylamino)-1-propanesulfonic acid), CAPSO (3-(Cyclohexylamino)-2-hydroxy-1-propanesulfonic acid), Ethanolamine, a mixture of ammonium chloride and ammonia, or a mixture of sodium hydroxide and sodium bicarbonate. Organophosphorous vapor at about 100 ppb is introduced after about 15 seconds at a flow rate of about 1 cm³/min and the sensor shows a response within seconds. This response shows that the mass-transport of organophosphorous molecules across the nanoporous membrane and into the liquid microchannel is fast enough for the oxime microreactor to be a viable, rapid-response organophosphorous sensor.

FIG. 32 shows experimental results for the effect of the pore size in the nanoporous membrane on sensor response. The liquid microchannel is about 0.25 mm wide, about 0.10 mm deep, and about 5 mm long and contains about 10 μM oxime solution in borate buffer (pH=10). Organophosphorous vapor at about 100 ppb enters the vapor micro-channel at a flow rate of about 1 cm³/min. The potential is reported after 30 seconds. As the pore size increases from about 10 nm to about 50 nm the response of the sensor also increases from about 11 mV to about 60 mV. Pore sizes above about 50 nm could not be tested due to flooding of the oxime solution into the vapor micro-channel. An increase in response for larger pores indicates that the mass transfer through the pore is faster with larger pores, leading to a faster response. With increasing pore diameter, the mass-transport increases due to an increase in open surface area and therefore porosity (Equation 12) of the nanoporous membrane. More open surface area increases the gas-liquid interface and allows more organophosphorous molecules to cross into the liquid microchannel.

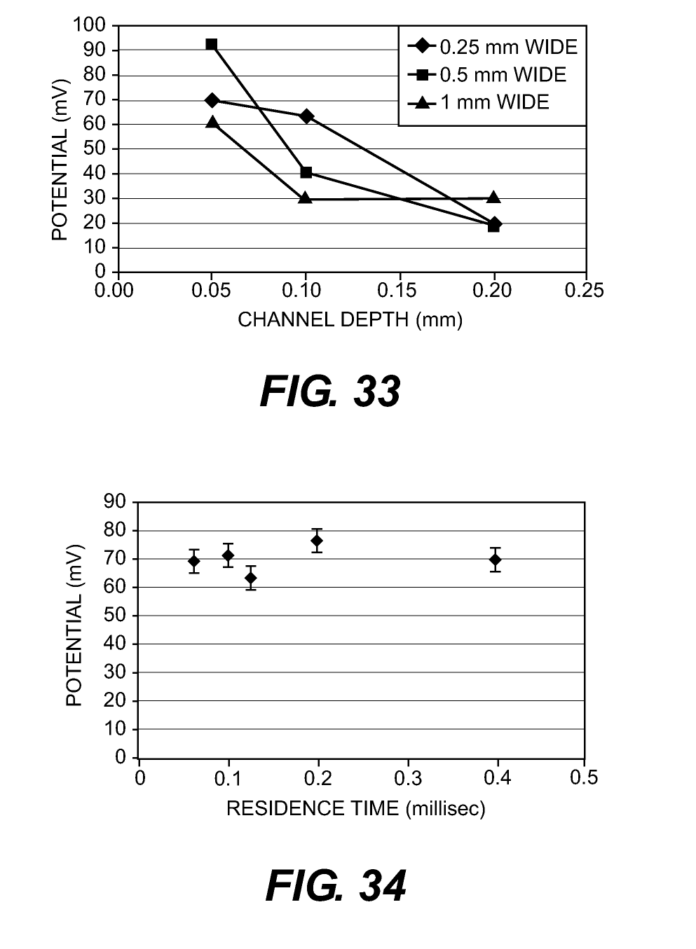

FIG. 33 shows the effect of channel depth on sensor response. The liquid microchannel is about 5 mm long and the depth and width of the channel are varied with a constant pore size of about 50 nm. The liquid microchannel contains about 10 mM oxime solution in borate buffer (pH=10). Organophosphorous vapor enter the vapor-microchannel at a concentration of about 100 ppb and a flow rate of about 1 cm³/min. The potential is reported after 30 seconds. As the liquid channel depth decreases from about 0.05 mm to about 0.2 mm the sensor response increases, for all channel widths. This result may be due to an increased build-up of cyanide ions or organophosphorous molecules at the electrode surface for smaller channel depths.

FIG. 34 shows the experimental results for the effect of vapor residence time on sensor response. The liquid microchannel is about 0.25 mm wide, about 0.10 mm deep, and about 5 mm long and contains about 10 mM oxime solution in borate buffer (pH=10). Organophosphorous vapor at about 100 ppb enters the vapor micro-channel at a flow rate of about 1 cm³/min. The potential is reported after 30 seconds. Vapor residence time has very little effect on the sensor response with an average potential response of about 73 mV and a standard deviation of 8.5 mV.

A comparison of the results found using numerical simulation and experimental data is shown in Table 4. In both experimental results and numerical simulations, varying the channel width and channel length had very little effect on sensor response. On the other hand, a decrease in channel depth by a factor of 4 more than doubles the sensor response for both simulation and experimental results. This result shows that in order to create the fastest response sensors should be fabricated with the smallest channel depth possible. The experimental results do not show the same trend as the numerical simulation when comparing hydrophobic and hydrophilic pores. This trend shows that the PVP-free polycarbonate membranes used in the microreactor are hydrophilic enough to wick the pores with oxime solution.

TABLE 4

| Geometric | | | Calculated | | | |
|---|---|---|---|---|---|---|
| Parameter | Range Studied | | slope | | Measured Slope | |
| Residence time | 0.05 to 0.5 | msec | 0 | | 0.004 ± 0.26 | mV/ms |
| Channel length | 1 mm to 8 | mm | 0 | | 0.5 ± 2.0 | mV/mm |
| Channel width | 0.25 to 1 | mm | 0 | | −6 ± 13 | mV/mm |
| Channel depth | 0.05 to 0.25 | mm** | −553 | mV/mm | −205 ± 63 | mV/mm |
| Pore size | 10 to 100 | nm* | 7.6 × 10⁶ ± 4 × 10⁶ | mV/mm | 1.2 × 10⁶ ± 0.4 x 10⁶ | mV/mm |

| | | |
|---|---|---|
| Pore | hydrophilic to | 100 |
| hydrophilicity | hydrophobia | |

*100 micron pores were also studied
**0.50 mm and 0.75 mm deep channels were also studied

Table 4 shows that residence time, in contrast to channel dimension, has almost no effect on the response of the sensor for both numerical simulation and experimental results. This trend appears due to the saturation of the gas-liquid interface with organophosphorous molecules. If the interface was not saturated, an increase in residence time would show an increase in sensor response. This trend also shows that the rate determining step in the transport of organophosphorous molecules occurs when the molecules cross the gas-liquid interface. Since the rate across the gas-liquid interface determines the rate of the mass-transport of organophosphorous molecules, the pore size and pore hydrophilicity of the nanoporous membrane are important.

Accordingly, Table 4 shows that increasing pore size increases sensor response. This increase is more pronounced in the experimental results and shows that increasing the surface area of the gas-liquid interface has a large impact on sensor response. In our simulation results, hydrophobic pores performed much better than hydrophobic pores due to wetting of the pores with oxime solution. Changing the pore hydrophilicity in the experimental results, however, did not have a great effect on sensor response. This is most likely due to the polycarbonate membrane, which is slightly hydrophilic. Comparison to the numerical simulation shows that the PVP-free polycarbonate membranes are still hydrophilic enough to wick the pores with oxime solution and provide a lower sensor response. Using a more hydrophobic membrane should prevent wetting of the membrane with oxime solution and further improve sensor response by increasing the contact area of the gas-liquid interface.

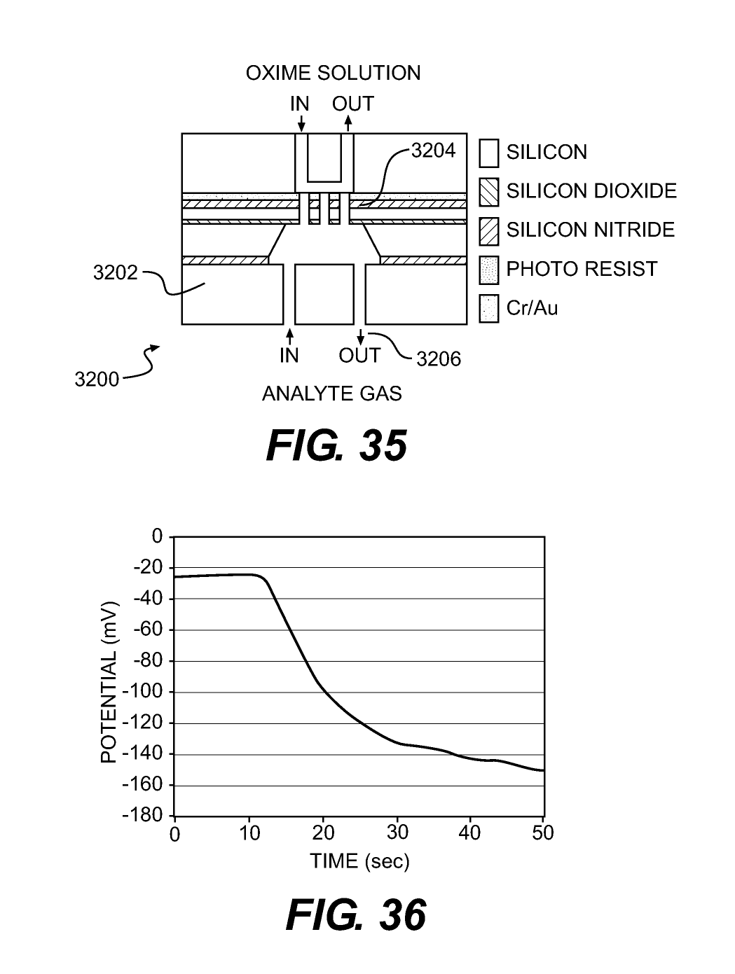

FIG. 35 shows a schematic of the Si based phosphonate sensor 3200. The sensor is composed of three parts: Si/SiO₂ pore layer 3202, liquid microchannel 3204, and gas microchannel 3206. In FIG. 32, the middle layer is the 6×6 circular straight Si pore with about 100 microns diameter. An SOI (silicon on insulator) wafer is etched using KOH wet etch and ICP-DRIE process leaving a membrane. Experiments were done with 20, 40 and 60 microns thick porous layers all giving similar effects. Those trained in the state of the art know that membranes up to about 500 microns could also be used, although they take longer to prepare. Silicon membranes thinner than 2 microns tend to be too fragile to be used. After cleaning in a piranha solution, the Si pore surface is made hydrophobic with FDTS (perfluorodecyltrichlorosilane) in an MVD (molecular vapor deposition) process. The FDTS-modified Si pore is hydrophobic enough to retain a water drop on the top with no leak through the pore. According to the following Laplace equation:

$$Δ P = \frac{2 γ cos θ}{a / 2} \qquad ( 15 )$$

where ΔP is the pressure difference, γ the surface tension of water (72 dyn/cm), θ the contact angle (105° for FDTS), and a the Si pore diameter, the estimated pressure drop of the liquid microchannel is 4.6×10⁻³ atm and, in that case, the maximum pore diameter that can maintain liquid on one side is calculated to be about 160 μm. Other designs give pressure drops of down to about 2×10⁻³ atm. In that case the maximum pore diameter is about 400 μm The Si pore is filled with photoresist and sputtered with 40-nm gold layer so that only the top surface of the Si pore is coated with gold. After removing the photoresist with organic solvent, liquid and gas microchannels are attached to the Si pore layer. Although the embodiments described herein use silicon and polydimethylsiloxane for the sensor system, it is understood that other materials, such as ceramic, metal or other materials may be used, and that one of ordinary skill in the art would recognize how to implement such materials in accordance with principles of the invention.

FIG. 36 shows a response from the Si based sensor. The liquid side is in contact with about 5 mM oxime solution (pH 10). The potential of the gold sensing electrode is measured with respect to a Ag/AgCl reference electrode. Initially, the electrode potential is stable at about −25 mV. When about 100 ppb of analyte gas begins to flow at a flow rate of about 1 mL/min along the gas microchannel, a potential response of about 150 mV is observed within tens of seconds.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

1. A microchannel system comprising:
a liquid microchannel;
a gas microchannel;
a membrane arranged between said liquid microchannel and said gas microchannel, wherein said membrane has hydrophobic properties; and
an ion selective electrode contacting said liquid microchannel.

2. The microchannel system of claim 1, further comprising a reference electrode coupled to an outlet of said liquid microchannel.

3. The microchannel system of claim 1, wherein said membrane is a nanoporous membrane having a pore size diameter in the range of about 50 nm and about 400 microns.

4. The microchannel system of claim 3, wherein said liquid microchannel and said gas microchannel has a depth in the range of about 0.2 mm to about 0.05 mm.

5. The microchannel system of claim 4 wherein said membrane having a thickness of between about 2 microns and about 500 microns.

6. The microchannel system of claim 4, wherein said liquid microchannel has width in the range of about 1 mm and about 0.05 mm.

7. The microchannel system of claim 1, wherein said ion selective electrode includes at least one element selected from the group consisting of gold and silver.

8. The microchannel system of claim 7, wherein said membrane is a polycarbonate membrane, and wherein said ion selective electrode is about 40 nm thick.

9. The microchannel system of claim 1, further comprising a coating on said membrane, wherein said coating causes said membrane to have the hydrophobic properties.

10. The microchannel system of claim 9, wherein said membrane is etched from a silicon on insulator.

11. The microchannel system of claim 1, wherein said membrane is a nanoporous membrane, and wherein a pore size diameter is based on the pressure in said liquid microchannel.

12. The microchannel system of claim 1, comprising a plurality of said liquid microchannels and a plurality of said gas microchannels.

13. The microchannel system of claim 12, wherein said plurality of said liquid microchannels share an inlet or an outlet.

14. The microchannel system of claim 1, wherein said liquid microchannel carries an electrolyte comprising an oxime solution.

15. The microchannel of claim 14 where the oxime solution comprises of 1-phenyl-1, 2, 3,-butanetrione 2-oxime (PBO) in a buffer.

16. The microchannel of claim 15, wherein the PBO concentration is in a range between about 10 μM and about 10 mM, and wherein the buffer has a pH of about 10.

17. The microchannel system of claim 1, wherein said liquid microchannel and said gas microchannel are formed from a polymer including specifically polydimethylsiloxane elastamer or polycarbonate.

18. A method of detecting organophosphates using a microchannel system having a liquid microchannel, a gas microchannel, and a membrane having hydrophobic properties, said method comprising the steps of:
coupling a reference electrode to an outlet of the liquid microchannel;
adding an electrolyte solution including an oxime compound to the liquid microchannel;
adding a gas including an organophosphate compound to the gas microchannel; and
measuring the open-circuit potential between the ion selective electrode and the reference electrode.

19. The method of claim 18, wherein the membrane has a pore size diameter in the range of about 50 nm and about 200 microns, and the membrane is arranged between the liquid microchannel and the gas microchannel; and
wherein the oxime solution is of 1-phenyl-1,2,3,-butanetrione 2-oxime (PBO) in a borate buffer compound microchannel.

20. The method of claim 18, wherein the thickness of the membrane is between about 2 microns and about 500 microns.

21. A method of making a microchannel system comprising the steps of:
forming a gas microchannel;
forming a liquid microchannel configured to receive an oxime compound;
forming a membrane having hydrophobic properties;
arranging the membrane between the liquid microchannel and the gas microchannel;
arranging an ion selective electrode in contact with the liquid microchannel; and
arranging a reference electrode at an outlet of the liquid microchannel.

22. The method of claim 21, wherein said step of forming the membrane includes forming a nanoporous membrane having a pore size diameter in the range of about 50 nm and about 400 microns.

23. The method of claim 21, wherein said steps of forming the microchannels include forming the liquid microchannel and the gas microchannel to a depth in the range of about 0.2 mm to about 0.05 mm.

24. The method in claim 21 wherein said step of forming the membrane includes forming to a thickness of between about 2 microns and about 500 microns.

25. The method of claim 21, wherein said step of forming the liquid microchannel includes forming to a width in the range of about 1 mm and about 0.05 mm.

26. The method of claim 21, wherein the ion selective electrode includes at least one element selected from the group consisting of gold and silver.
